(19) United States
(12) Patent Application Publication
(10) Pub. No.: US 2025/0390044 A1
(43) Pub. Date: Dec. 25, 2025

(54) IMAGE FORMING APPARATUS

(71) Applicant: Konica Minolta, Inc., Tokyo (JP)

(72) Inventors: Noriyuki KINPARA, Tokyo (JP); Kazutoshi KOBAYASHI, Tokyo (JP); Kazukuni NISHIMURA, Tokyo (JP)

(21) Appl. No.: 19/236,305

(22) Filed: Jun. 12, 2025

(30) Foreign Application Priority Data
Jun. 24, 2024 (JP) 2024-101235

(51) Int. Cl. G03G 15/20; G03G 15/00; G03G 15/16

(52) U.S. Cl. CPC G03G 15/206; G03G 15/1685; G03G 15/2028; G03G 15/2064; G03G 15/657; G03G 2215/00413; G03G 2215/2029

(57) ABSTRACT

An image forming apparatus includes: a support body; an elastic member in close contact with the support body; an endless belt; and a nip portion. The nip portion is formed by the elastic member and the endless belt. The support body in close contact with the elastic member pressed at the nip portion is made of an aluminum alloy containing silicon. The content of silicon in the aluminum alloy is within a range of 0.8 to 12.0% by mass.

### CROSS-REFERENCE TO RELATED APPLICATIONS

The entire disclosure of Japanese Patent Application No. 2024-101235 filed on Jun. 24, 2024 is incorporated herein by reference in its entirety.

### BACKGROUND OF THE INVENTION

### Technical Field

The present invention relates to an image forming apparatus. More specifically, the present invention relates to an image forming apparatus capable of maintaining good conveyance performance of recording media for a long time.

### Description of Related Art

Various processes are performed in image formation. For example, in conveying a recording medium in a fixed state, excellent conveyance performance is required. In conveying a recording medium, typically, an elastically deformable member is provided on the surface layer of the support body that receives a pressing force, and a nip portion is formed between the pressing member and the pressed member. The recording medium is conveyed in the fixed state by being passed through the nip portion. The recording medium is then conveyed by rollers and a conveyance belt. Such rollers are each constituted by a support body made of aluminum or iron and a member made of silicone rubber formed on the surface of the support body, for example.

In addition to the process of fixing and conveying the recording medium, various processes are performed in image formation, such as a process of transferring toner to a recording medium and a process of efficiently applying heat and pressure to the toner on the recording medium to fix the toner. For these processes, various functions as well as the function of maintaining excellent conveyance performance are to be improved, and various technologies have been disclosed.

For example, Japanese Unexamined Patent Publication No. 2001-282023 discloses improving the fixability of toner. According to JP2001-282023A, in the toner fixing process, manganese-based aluminum alloys are used as a core metal material of a fixing roller to improve the strength of the aluminum alloys; and the core metal is thinned, so that the heat transfer coefficient is increased.

JP2009-186640 discloses achieving both low-temperature fixability and sheet separability in the toner fixing process by improving the structure of toner.

In recent years, further improvements have been required in processes such as a transfer process and a fixing process to increase an image forming speed and in view of energy saving. Further, to cope with various recording media such as thin paper and embossed paper, there have been higher demands for improving the function of maintaining a conveyance performance in the conveying process.

In performing printing for a long time, both good toner fixability and good conveyance performance of the recording medium can be maintained in an early stage of printing. However, in a later stage of printing, it is difficult to maintain both the toner fixability and the conveyance performance. Specifically, the conveyance performance of the recording medium cannot be maintained.

The above-described problem is caused by the deterioration of members constituting the image forming apparatus as the number of times of printing increases. The deterioration of members affects the pressure distribution on a recording medium in printing. The above-described problem is more likely to occur when thin paper is used as the recording medium.

According to the technology disclosed in JP2001-282023A, the fixability of toner can be improved. However, in a later printing stage in long-term printing, the technology cannot cope with a change in distribution of pressures applied to the recording medium and cannot maintain conveyance performance of the recording medium in a conveyance process.

Although the technology disclosed in JP2009-186640A can achieve both low-temperature fixability and sheet separability in the fixing process, it cannot maintain the conveyance performance of recording medium in the late stage of long-term printing, similarly to JP2001-282023A.

As described above, according to the known technology, it is difficult to satisfy high-level demands for the fixing process and the conveyance process in long-term printing. Further functional improvements of an image forming apparatus have been awaited.

The present invention has been conceived in view of the above-described problems and situations. An object of the present invention is to provide an image forming apparatus capable of maintaining satisfactory conveyance performance of recording media for a long time.

### SUMMARY OF THE INVENTION

In order to solve the above-described problems, the inventors of the present invention studied the causes of the above problems and found that the following can solve the problems: (1) a support body in close contact with an elastic member that receives pressing force at a nip portion formed by components of the image forming apparatus is made of silicon-containing aluminum alloy; and (2) the content of silicon in the aluminum alloy is within the range of 0.8 to 12.0% by mass.

That is, the above-described problems according to the present invention are solved by the following means.

To achieve at least one of the abovementioned objects, according to an aspect of the present invention, there is provided an image forming apparatus including: a support body; an elastic member in close contact with the support body; an endless belt; and a nip portion, wherein: the nip portion is formed by the elastic member and the endless belt, the support body in close contact with the elastic member pressed at the nip portion is made of an aluminum alloy containing silicon, and a content of silicon in the aluminum alloy is within a range of 0.8 to 12.0% by mass.

The present invention can provide an image forming apparatus that maintains satisfactory conveyance performance of recording media for a long time.

Although the mechanism of the effect of the present invention is not clear, the inventors infer the mechanism as follows.

In the image forming apparatus of the present invention, the support body in close contact with the elastic member that receives pressing force at a nip portion formed by components of the image forming apparatus is made of silicon-containing aluminum alloy; and the content of silicon in the aluminum alloy is within the range of 0.8 to 12.0% by mass.

In long-term printing, the components of the image forming apparatus deteriorate as the number of times of printing increases. Some components of the image forming apparatus affect the conveyance performance of the recording medium. Such components generally include a support body, an elastic member in close contact with the support body, and an endless belt.

The nip portion according to the present invention is formed by the elastic member and the endless belt. In printing, the pressure applied from the nip portion to the elastic member is maintained at an appropriate distribution, so that the close contact between the support body and the elastic member is appropriately maintained for a long time.

The close contact between the support body and the elastic member is appropriately maintained for a long time if the surface of the support body in contact with the elastic member has an appropriate surface roughness. The surface roughness of the support body is appropriately maintained for a long time by using the support body made of an aluminum alloy containing silicon and by setting the silicon content in the aluminum alloy within a range of 0.8 to 12.0% by mass.

If the surface roughness of the support body is maintained for a long time, misalignment between the support body and the elastic member is less likely to occur for a long time. Accordingly, the pressure applied to the endless belt in contact with the elastic member can be stably maintained. Therefore, it is estimated that the distribution of pressure applied to the nip portion is appropriately maintained in long-term printing and that the image forming apparatus can appropriately convey the recording medium for a long time.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 is a diagram for explaining a state of silicon in temperature changes;

FIG. 2 is an image of the eutectic state of aluminum alloy containing 7% by mass of silicon;

FIG. 3 is an image of the eutectic state of aluminum alloy containing 12.6% by mass of silicon;

FIG. 4 is an image of the eutectic state of aluminum alloy containing 18% by mass of silicon;

FIG. 5 is an example of a schematic cross-sectional view of an overall configuration of an image forming apparatus;

FIG. 6 is an example of a schematic cross-sectional view of a configuration of a fixing section;

FIG. 7 is an example of a block diagram illustrating a configuration of a controller; and

FIG. 8 is an example of a schematic cross-sectional view of a configuration of the fixing section.

### DETAILED DESCRIPTION

Hereinafter, one or more embodiments of the present invention will be described with reference to the drawings. However, the scope of the invention is not limited to the disclosed embodiments.

An image forming apparatus of the present invention includes: a support; an elastic member in close contact with the support; an endless belt; and a nip portion. The nip portion is formed by the elastic member and the endless belt. The support that is in close contact with the elastic member pressed against the nip portion is made of an aluminum alloy containing silicon. The silicon content in the aluminum alloy is in a range of 0.8 to 12.0% by mass.

This technical feature is common to or corresponds to the following embodiments (aspects).

As an embodiment of the present invention, it is preferable that the endless belt conveys a recording medium and that at least one of the nip portions is formed by the elastic member and the belt for conveying the recording medium, from the viewpoint of improving the conveyance performance of the recording medium.

The copper content in the aluminum alloy is preferably 1.1% by mass or less to improve the adhesion between the support and the elastic member while improving the processability of the support.

To improve the conveyance performance of the recording medium, it is preferable that the nip portion is formed by the endless belt and two rotating members that face each other with the endless belt in-between.

To improve the conveyance performance of the recording medium, it is preferable that the image forming apparatus includes: a support that is provided on the inner side of the endless belt and that is to be in close contact with the elastic member pressed at the nip portion; and a pressure rotor that is provided on the outer side of the endless belt and that presses the elastic member at the nip portion.

The present invention is also suitably applicable to a case where: the image forming apparatus includes a transfer unit, and the nip portion is formed by a component constituting the transfer unit.

The present invention is also suitably applicable to a case where the image forming apparatus includes a fixing unit, and the nip portion is formed by a member constituting the fixing unit.

The present invention is also suitably applicable to a case where the fixing unit includes a heating member.

Hereinafter, the present invention, constituent elements thereof, and forms and aspects for carrying out the present invention will be described in detail. In the present description, when two figures are used to indicate a range of value before and after “to”, these figures are included in the range as a lower limit value and an upper limit value.

Note that the advantages and features provided by one or more embodiments of the present invention will be more fully understood from the following detailed description and the accompanying drawings which are given by way of illustration only. Accordingly, it is not intended to define the limits of the present invention.

### [Image Forming Apparatus]

### 1. Overview

An image forming apparatus of the present invention includes: a support body; an elastic member in close contact with the support body; an endless belt; and a nip portion. The nip portion is formed by the elastic member and the endless belt. The support body that is in close contact with the elastic member pressed against the nip portion is made of an aluminum alloy containing silicon. The silicon content in the aluminum alloy is in a range of 0.8 to 12.0% by mass.

The effect of the present invention is particularly prominent in a fixing unit that is likely to deteriorate by heat. The present invention is not limited thereto, though. Further, the present invention can be applied not only to an image forming apparatus using an electrophotographic process but also to an image forming apparatus that applies heat to a printed image to laminate the image.

### (Definition of Nip Portion)

The “nip portion” in the present invention refers to a portion where a pressing member is in contact with a pressed member among components of an image forming apparatus.

For example, when an endless belt is the pressing member and an elastic member that is in close contact with the support is the pressed member, the nip portion is a portion where the endless belt is in contact with the elastic member.

Assume a case where a member A and a member B are provided with the endless belt interposed in-between; the member A is a fixing roller; and the member B includes a support body and an elastic member that is in close contact with the support body. In this case, the endless belt can be regarded as the pressing member, and the elastic member can be regarded as the pressed member. In this case, the nip portion is the portion where the endless belt is in contact with the elastic member.

Assume a case where a member A and a member B are provided with the endless belt interposed in-between; the member A is a fixing roller; and the member B includes a support body and an elastic member that is in close contact with the support body. In this case, the endless belt can be regarded as the pressed member, and the elastic member can be regarded as the pressing member. In this case, the nip portion is a portion where the endless belt is in contact with the fixing roller.

It can also be considered that the member A presses the member B with the endless belt in-between. In this case, the pressing member is the member A (the fixing roller), and the pressed member is the member B that includes the support body and the elastic member in close contact with the support body. In this case, (i) a portion where the endless belt is in contact with the fixing roller and (ii) a portion where the endless belt is in contact with the elastic member are collectively referred to as “nip portions”.

Therefore, the “nip portion” in the present specification includes not only the contact portion between the endless belt and the elastic member but also the contact portion between the endless belt and the fixing roller.

The image forming apparatus of the present invention includes: a nip portion(s) formed by a pressing member and a pressed member; an elastic member that is affected by a pressing force from the nip portion; and a support in close contact with the elastic member.

The adhesion of the support body to the elastic member varies depending on the surface roughness of the support body. When the support body is made of an aluminum alloy and the silicon content in the aluminum alloy is within an appropriate range, good adhesiveness can be maintained. Specifically, the silicon content is in a range of 0.8 to 12.0% by mass.

### (1.1) Elements of Aluminum Alloy

When the silicon content in the aluminum alloy exceeds 0.6% by mass, a sea-island structure in which microcrystals (eutectics) of silicon are dispersed in an aluminum phase is formed, and appropriate irregularities are formed on the outer peripheral surface of the support body. However, when the silicon content in the aluminum alloy is less than 0.8% by mass, crystals do not grow sufficiently, and the outer peripheral surface of the support body does not have appropriate surface roughness. Accordingly, adhesiveness is insufficient.

In addition, when the content of silicon in the aluminum alloy is 12.6% by mass or less, coarse crystals (projections) formed by eutectic crystals of silicon and aluminum are less likely to form. On the other hand, when the silicon content in the aluminum alloy is greater than 12.0% by mass, the outer peripheral surface of the support body does not have appropriate surface roughness, resulting in insufficient adhesion.

In view of the above, the content of silicon in the aluminum alloy is within a range of 0.8 to 12.0% by mass to improve the adhesion between the support body and the elastic member in close contact with the support body and to exhibit the effect of the present invention. Further, the silicon content in the aluminum alloy is preferably in a range of 5.0 to 10.0% by mass to improve the adhesion.

### (Metal Elements)

The aluminum alloy contains, in addition to silicon, metal elements such as copper, iron, manganese, and magnesium to secure the strength thereof.

The inclusion of copper in the aluminum alloy is preferable for improving processability of the support body and prevents defects. However, if the aluminum alloy contains too much copper, the formation of the Si—Al eutectic is inhibited, and appropriate surface roughness cannot be obtained. Accordingly, the effect of the present invention may not be obtained.

Therefore, the copper content in the aluminum alloy is preferably 1.1% by mass or less to improve the adhesion between the support body and the elastic member while improving the processability of the support body.

With respect to the metal elements other than copper, namely iron, manganese, and magnesium, excessive contents thereof and excessive strength of the aluminum alloy affect the processability of the support body and the run-out accuracy required for the support body. It is therefore preferable that the content of metal elements such as iron, manganese, and magnesium is 5.0% by mass or less. Note that the term “run-out accuracy” means a total run-out tolerance in an axial direction or a circumferential direction defined in JIS B0021.

### (State of Silicon)

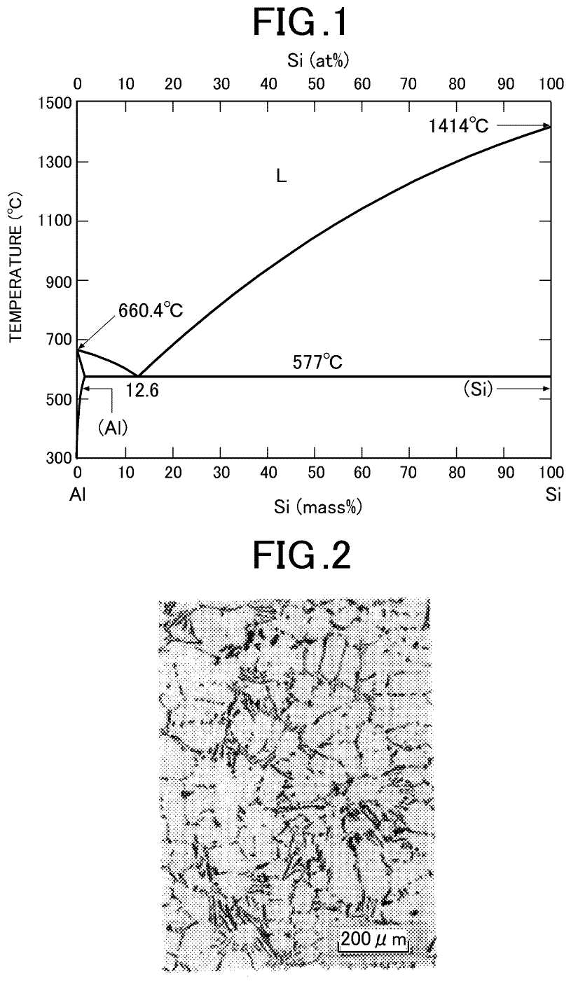

FIG. 1 is a diagram for explaining the state of silicon in temperature changes. The silicon-containing aluminum alloy is, for example, a eutectic system having a eutectic point at 577° C. and a silicon-content ratio of 12.6% by mass as shown in FIG. 1. When the alloy in a liquid state (L) is cooled, the alloy undergoes eutectic solidification. Hereinafter, the “aluminum alloy containing silicon” is also simply referred to as “Si—Al alloy”.

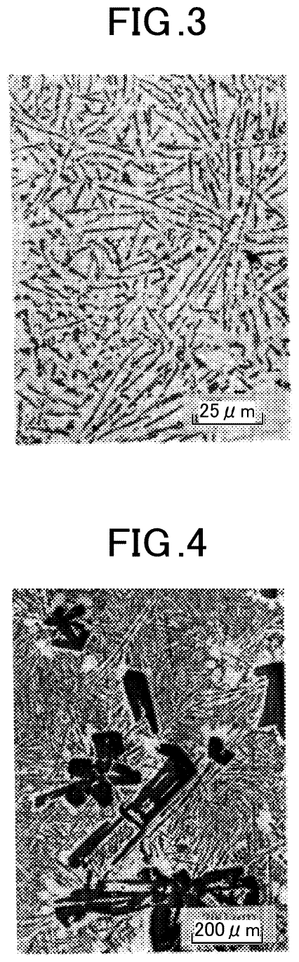

FIG. 2, FIG. 3, and FIG. 4 are part of images showing eutectic states of the microstructure of powder samples of the silicon-containing aluminum alloy. FIG. 2 is an image capturing a eutectic state at a silicon content rate of 7% by mass. FIG. 3 is an image capturing a eutectic state at a silicon content rate of 12.6% by mass. FIG. 4 is an image capturing a eutectic state at a silicon content rate of 18% by mass.

The crystals of silicon crystallized as eutectic crystals hardly dissolve aluminum as a solid solution and grow as a thin and narrow plate crystal as illustrated in FIG. 3. On the other hand, when the silicon content is increased to form a hypereutectic state, anisotropic coarse crystals are formed as illustrated in FIG. 4.

The surface of the Si—Al alloy in the eutectic composition region has a sea-island structure as shown in FIG. 2 or FIG. 3 and provides surface roughness corresponding to the silicon content (Kitaoka Sanji et al., Light Metals, Vol. 38, (7), 426, 1988).

In the present invention, when the silicon content of the support body made of aluminum alloy is within the range of 0.8 to 12.0% by mass, minute irregularities are formed on the surface of the support body, and the support body has appropriate surface roughness. Thus, the adhesion between the support body and the elastic member in contact with the support body is improved.

Therefore, even in long-time printing, it is possible to stably maintain the pressure distribution applied to the elastic member at the nip portion formed by the elastic member and the belt in the image forming apparatus. Accordingly, the recording media are appropriately conveyed for a long time.

### (Method for Measuring Element Contents)

The element content in the support body made of an aluminum alloy according to the present invention can be measured by a known elemental analysis method using metal piece spectroscopy of the support body. Specifically, the element content in the support body is measured by qualitative and quantitative analysis using a fluorescent X-ray analyzer “XRF-1700” (manufactured by Shimadzu Corp.) under the following measurement conditions.

### <Measurement Conditions>

Slit: standard
Attenuator: none
Analyzing crystal (Cu=LiF, Si=PET)
Detector (Cu=SC, Si=FPC)

### (1.2) Method for Adjusting Composition of Aluminum Alloy

Aluminum alloys may be refined from bauxite but are often produced from scraps of aluminum alloys for saving resources and energy and reducing carbon dioxide emissions.

Since the scraps of aluminum alloys inevitably contain non-aluminum elements, it is necessary to adjust the composition of the aluminum alloy.

Further, a metal element other than aluminum is added to an aluminum alloy for controlling physical properties and workability, no matter whether the aluminum alloy is a recycled one or not.

Silicon is added to various kinds of aluminum alloys because silicon affects heat resistance, thermal expansibility, and workability. An aluminum alloy containing silicon is utilized as a member of an electrophotographic image forming apparatus.

Scraps of an aluminum alloy the contents of which are clear may be used as the aluminum raw material for the components of the image forming apparatus of the present invention. Metallic silicon and so forth may also be added for adjusting components.

The composition of the aluminum alloy can be adjusted by melting two or more kinds of aluminum raw materials. In the following description, two kinds of aluminum raw materials (a first raw material and a second raw material) are used, and the composition of the aluminum alloy is adjusted by mixing the second raw material with the first raw material.

According to the present invention, the content of silicon in the aluminum alloy is within a range of 0.8 to 12.0% by mass. For example, when the content of silicon in the first raw material is greater than 12.0% by mass, the silicon content of the second raw material is decreased to be less than in the first raw material to dilute silicon in the aluminum alloy.

Conversely, when the silicon content of the first raw material is less than 0.8% by mass, the silicon content of the second raw material is increased to be greater than in the first raw material to enrich silicon in the aluminum alloy.

In production of an aluminum alloy, if the element content in the first raw material is not within the desired range, the composition of the aluminum alloy as a final product can be adjusted by diluting or enriching the element using the second raw material, in the same manner as adjusting the silicon content described above.

As the aluminum raw material, a standardized aluminum alloy may be melted and used.

Examples of the above-described aluminum alloy include JIS2000 aluminum, JIS3000 aluminum, JIS4000 aluminum, JIS5000 aluminum, JIS6000 aluminum, and JIS7000 aluminum.

(1.3) Method for Processing Aluminum Alloy into Support Body Shape A wrought material of an aluminum alloy can be processed into a support body shape by a known method, such as rolling, extrusion, or casting, for example. Two or more of these methods may be used in combination.

### 2. Overall Configuration of Image Forming Apparatus

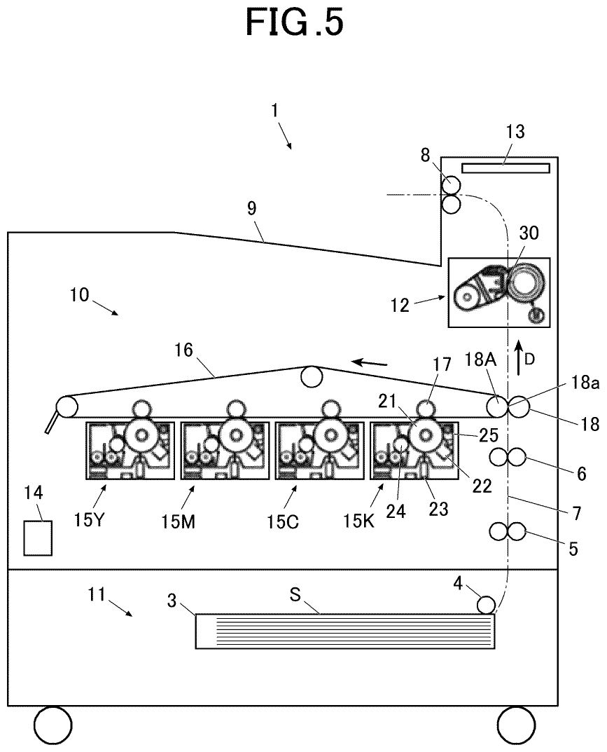

FIG. 5 is an example of a schematic cross-sectional view illustrating an overall configuration of an image forming apparatus.

The image forming apparatus 1 includes an image forming section 10, a conveyance section 11, a fixing section 12, an operation section 13, and a controller 14. The image forming apparatus 1 also includes a secondary transfer roller 18.

### (2.1) Image Forming Section

The image forming section 10 includes image forming units 15Y, 15M, 15C, and 15K, an intermediate transfer belt 16, and primary transfer rollers 17.

### (Image Forming Unit)

The image forming units correspond to the respective colors of Y (yellow), M (magenta), C (cyan), and K (black). The image forming units 15K, 15Y, 15M, and 15C have the same configuration. Each image forming unit forms a toner image of a corresponding color (K, Y, M, or C color) on the photoreceptor.

The operations of the image forming units 15K, 15Y, 15M, and 15C are performed at different timings so that the toner images are primarily transferred to the same position on the intermediate transfer belt 16 and thereby superposed on each other. Thus, a color toner image of yellow (Y), magenta (M), cyan (C), and black (K) is formed on the intermediate transfer belt 16.

Since the image forming units 15K, 15Y, 15M, and 15C have the same configuration, the image forming unit 15K corresponding to the color of K (black) is described below.

The image forming unit 15K includes a photoreceptor 21, a charging section 22, an exposure section 23, a developing section 24, and a cleaner 25.

### [Photoreceptor]

The photoreceptor bears a latent image or a visible image on its surface in an electrophotographic image forming method. In image formation, first, the surface of the photoreceptor is charged to generate a potential difference between the surface of the photoreceptor and the surface of the support. Next, charges are generated from the photosensitive layer by an exposure device, and the charges cancel out charges on the surface of the photoreceptor, whereby an electrostatic latent image is formed on the surface of the photoreceptor. Subsequently, a developing bias voltage is applied to the developer bearing member so that the toner is electrostatically attracted from the developer bearing member to the latent image portion on the surface of the photoreceptor, and the toner image is developed on the photoreceptor.

The photoreceptor 21 is preferably composed of a support body made of an aluminum alloy containing silicon and an elastic member that is to be in close contact with the support body. In that case, the silicon content in the aluminum alloy is preferably within a range of 0.8 to 12.0% by mass. Thereby, the distribution of pressure from the nip portion is stably maintained, and the effect of the present invention is further enhanced. The photoreceptor 21 is located opposite the primary transfer roller 17 with the intermediate transfer belt 16 in-between. The photoreceptor 21 is pressed by the primary transfer roller with the intermediate transfer belt 16 in-between, and a nip portion is formed at a contact portion between these members.

Further, the photoreceptor 21 is pressed by a developing roller of the developing section 24, and a nip portion is formed at a contact portion between the photoreceptor 21 and the developing roller.

The photoreceptor 21 is uniformly charged by the charging section 22. The photoreceptor 21 is driven to rotate by a drive source (not illustrated) and is exposed to laser light emitted by the exposure section 23, so that an electrostatic latent image is formed on the surface of the photoreceptor 21.

### [Charging Section]

The charging section 22 is arranged along a circumferential direction of the photoreceptor 21. The charging section 22 uniformly charges the photoreceptor 21.

### [Exposure Section]

The exposure section 23 includes a light emitting element, such as a laser diode, and a lens. The exposure section 23 modulates laser light to expose and scan the surface of the photoreceptor 21 in accordance with drive signals from the controller 14. When the photoreceptor 21 is exposed to the laser light in the state of being uniformly charged by the charging section 22, an electrostatic latent image is formed on the surface of the photoreceptor 21.

### [Developing Section]

The developing section 24 supplies a developer to the surface of the photoreceptor, develops the electrostatic latent image formed on the surface of the photoreceptor 21, and thereby forms a toner image. The developing section 24 may include a lubricant supplying means that supplies a lubricant to the developer. It is preferable that the developer contains a lubricant for improving abrasion resistance.

The developing section 24 includes a developer bearing member. The developer bearing member is rotated to convey the developer to the photoreceptor 21. The thin toner layer on the developer bearing member comes into contact with the photoreceptor 21 and develops the electrostatic latent image on the photoreceptor 21.

The developer bearing member is connected to a voltage application device. The voltage applying device applies a DC and/or AC bias voltage to the developer bearing member. The voltage applied to the developer bearing member is controlled to adjust the developing bias to a desired value.

Due to the potential difference (developing potential difference) between the developer bearing member and the electrostatic latent image carried by the photoreceptor 21, an electric field is formed in the developing section where the developer bearing member and the photoreceptor 21 face each other. The toner in the developer conveyed by the rotation of the developer bearing member moves by the action of the force received from the electric field, and the toner is attracted to the electrostatic latent image on the photoreceptor 21. When the electrostatic latent image carried on the photoreceptor 21 is visualized, a toner image corresponding to the shape of the electrostatic latent image is formed on the surface of the photoreceptor 21.

The developer bearing member is composed of, for example, a developing sleeve, a flange, a shaft and a magnet roller. The “developing sleeve” is a means having a function of bearing the appropriately charged developer and supplying the developer to the photoreceptor on which the electrostatic latent image is formed. The developing sleeve is, for example, a part of the developer bearing member of the developing section constituting the electrophotographic image forming apparatus.

The developer bearing member that includes the “developing sleeve” as a part of the configuration thereof may not include a magnet portion, such as a magnet roller, as a part of the configuration thereof. The shape of the above-described developing sleeve is not a simple cylindrical shape as disclosed in Japanese Unexamined Patent Publication No. 2003-91084 and does not include a configuration of a tube having holes like a lotus root in its cross section.

The content of silicon in the aluminum alloy in the material constituting the developer bearing member is preferably within a range of 0.8 to 12.0% by mass. The aluminum alloy that forms the developer bearing member does not include materials that form the flange, the shaft, and the magnet roller.

### [Cleaner]

The cleaner 25 removes the toner remaining on the surface of the photoreceptor 21 before the photoreceptor 21 is exposed to laser light emitted by the exposure section 23.

### (Intermediate Transfer Belt)

The intermediate transfer belt 16 is an aspect of the endless belt according to the present invention. The nip portion according to the present invention is formed by the intermediate transfer belt 16, the primary transfer roller 17, and the photoreceptor 21 that faces the primary transfer roller 17 with the intermediate transfer belt 16 in-between.

### (Primary Transfer Roller)

The primary transfer roller 17 is one aspect of the “transfer unit” according to the present invention. The primary transfer roller 17 is in contact with the circulating intermediate transfer belt 16 and is disposed on a side opposite the photoreceptor 21. The primary transfer roller 17 transfers the toner image formed on the photoreceptor 21 to the intermediate transfer belt 16, which is an endless belt.

The image forming apparatus 1 uses an intermediate transfer method in which the toner image in K color formed on the photoreceptor 21 is transferred onto the intermediate transfer belt 16 by the primary transfer roller 17, and the toner image on the intermediate transfer belt 16 is transferred onto a recording medium by the secondary transfer roller 18. The present invention is not limited to the intermediate transfer method. The present invention is also applicable to a direct transfer method in which a toner image formed on a photoreceptor is directly transferred to a recording medium.

### (2.2) Conveyance Section

The conveyance section 11 includes a sheet feed cassette 3, a feed roller 4, a pair of conveyance rollers 5, and a pair of timing rollers 6.

The sheet feed cassette 3 houses recording media.

The feed roller 4 is in contact with the topmost recording medium S in the sheet feed cassette 3 and delivers the recording medium S to the conveyance belt 7. The conveyance belt 7 is an aspect of the endless belt according to the present invention.

The pair of conveyance rollers 5 conveys the recording medium S fed by the feed roller 4 toward the pair of timing rollers 6.

The pair of timing rollers 6 delivers the recording medium S to the downstream side at timings instructed by the controller 14.

### (2.3) Secondary Transfer Roller

The secondary transfer roller 18 is an aspect of the transfer unit according to the present invention. The nip portion according to the present invention is formed by the intermediate transfer belt 16, the primary transfer roller 17, and a roller 18A that faces the primary transfer roller with the intermediate transfer belt 16 in-between.

The roller 18A is preferably composed of a support body made of an aluminum alloy containing silicon and an elastic member. In that case, the silicon content in the aluminum alloy is within a range of 0.8 to 12.0% by mass. Thus, the adhesion between the support body and the elastic member in contact with the support body is improved, and the good conveyance performance of the recording medium can be maintained for a long time.

The recording medium S is conveyed on the conveyance belt 7 from the pair of timing rollers 6 of the conveyance section 11 and passes through the secondary transfer position 18a according to the timing of the toner image on the circulating intermediate transfer belt 16.

When the recording medium S passes through the secondary transfer position 18a, the toner image on the intermediate transfer belt 16 is secondarily transferred to the recording medium S by the secondary transfer roller 18. The recording medium S that has passed through the secondary transfer position 18a is sent to the fixing section 12.

### (2.4) Fixing Section

The fixing section 12 is one aspect of the fixing unit according to the present invention. The recording medium S conveyed from the secondary transfer roller 18 in the direction of arrow D is passed through the fixing nip 30, where the toner image on the recording medium S is fixed onto the recording medium S by heat and pressure. The fixing nip 30 is an aspect of the nip portion according to the present invention.

The recording medium S having passed through the fixing section 12 is ejected outside the apparatus by a pair of ejection rollers 8 and is stored in a sheet ejection tray 9.

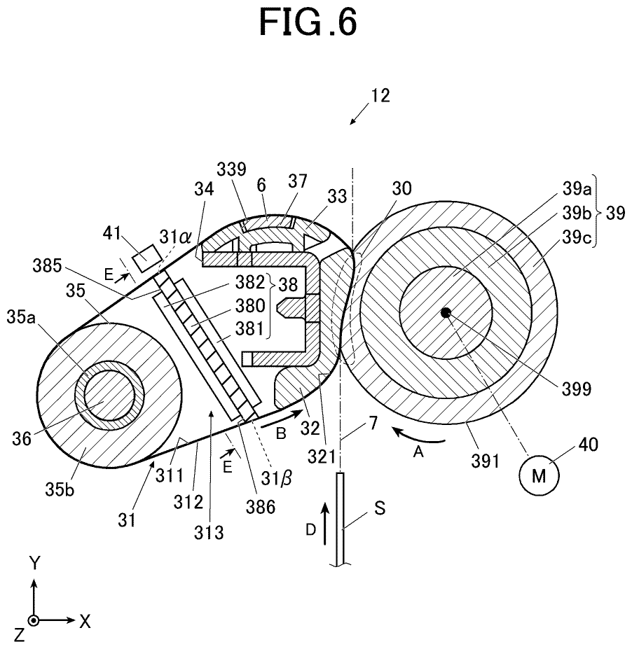

FIG. 6 is an example of a schematic cross-sectional view of the configuration of the fixing section 12.

In FIG. 6, the X-axis direction is the left-right direction when the image forming apparatus 1 is viewed from the front side. The Y-axis direction is the vertical direction when the image forming apparatus 1 is viewed from the front side. The Z-axis direction is a direction perpendicular to both the X axis and the Y axis and corresponds to a depth direction of the image forming apparatus 1. FIG. 6 is a lateral cross-sectional view of the fixing section 12 along the X-Y plane perpendicular to the Z axis.

The fixing section 12 includes members disposed outside the fixing belt 31 and members disposed inside the fixing belt 31.

### (2.4.1) Members Disposed Outside Fixing Belt

The members disposed outside the fixing belt 31 are the pressure roller 39, the drive motor 40, the endless fixing belt 31, and so forth. A non-contact temperature sensor 41 is disposed outside the fixing belt 31.

### (Pressure Roller)

The pressure roller 39 presses, from the outer circumferential surface 312 of the fixing belt 31, the press pad 32 disposed on the inner side of the fixing belt 31 with the fixing belt 31 in-between.

The pressure roller 39 is driven to rotate at a predetermined speed in the direction of arrow A by the rotational driving force of the drive motor 40. By the rotation of the pressure roller 39, the fixing belt 31 is driven to rotate (run) in the direction of arrow B.

The pressure roller 39 includes an elastic layer 39b made of a material having high heat resistance (e.g., silicone rubber or fluororubber) and a release layer 39c having releasability (e.g., a fluororesin tube or fluorine-based coating) formed in this order on a solid shaft body 39a made of aluminum, steel, and so forth. The shaft body 39a is not limited to a solid body but may be a metal pipe, for example.

The shaft center 399 of the shaft body 39a of the pressure roller 39 is parallel to the Z axis. Both ends of the pressure roller 39 in the axis direction are supported by a not-illustrated fixed frame that forms part of the housing of the fixing section 12 such that the pressure roller 39 is rotatable and swingable in a direction toward and farther from the fixing belt 31 (a near-far direction). Hereinafter, the fixed frame may be simply referred to as the frame.

The outer circumferential surface 391 of the pressure roller 39 is pressed against the fixing belt 31 by an urging force of a spring (not illustrated).

The pressing force P of the pressure roller 39 against the press pad 32 inside the fixing belt is switchable by a pressing force switching mechanism (not illustrated).

When an image is formed, the pressing force is set to the full pressure. When an image is not formed (e.g., during standby or during execution of a bypass path heating mode described later), the pressing force is set to a light pressure less than the full pressure.

The pressing force is switched to the light pressure when an image is not formed to prevent deformation of the pressure roller 39. If the pressure roller 39 not in motion is kept elastically deformed by the strong full pressure, plastic deformation may occur in which the pressure roller 39 is greatly deformed and does not return to its original shape of a circular cross section. Such plastic deformation can be prevented by switching to a light weak pressure when an image is not formed.

### (Drive Motor)

The drive motor 40 is, for example, a brushless DC motor.

When the rotation speed of the pressure roller 39 becomes lower than a predetermined speed, the controller 14 slightly increases the current supplied to the drive motor 40 to prevent a decrease in the rotation speed of the pressure roller 39.

When the rotation speed of the pressure roller 39 exceeds the predetermined speed, the controller 14 slightly reduces the current supplied to the drive motor 40 to prevent an increase in the rotation speed of the pressure roller 39 (roller rotation control).

By the roller rotation control described above, the rotation speed of the pressure roller 39 is maintained at a predetermined speed, and the running speed of the fixing belt 31 that is driven to rotate by the pressure roller 39 is also stably maintained at the same speed as the circumferential speed of the pressure roller 39.

A torque sensor 42 for detecting the torque of the drive motor 40 is provided. The torque sensor 42 measures the value of current supplied to the drive motor 40, for example. Based on the detection result of the torque sensor 42, the magnitude of the rotation load of the pressure roller 39 is determined.

### (Temperature Sensor)

The non-contact temperature sensor 41 that detects the temperature of the fixing belt 31 is disposed outside the fixing belt 31 and in the vicinity of the first position 31α. The temperature sensor 41 sends a temperature detection result of the fixing belt 31 to the controller 14.

In image formation, based on the temperature detected by the temperature sensor 41, the controller 14 performs temperature adjustment control of turning on and off the heater 36 so that the temperature of the fixing belt 31 is maintained at a fixing temperature T1 suitable for fixing, for example, 160° C.

By the temperature adjustment control in image formation, when the recording medium S conveyed on the conveyance belt 7 passes through the fixing nip 30, the unfixed image on the recording medium S is heated, melted, and pressed, and thereby being fixed on the recording medium S. The temperature sensor 41 is not limited to a non-contact type but can be a contact type that comes into contact with the outer peripheral surface 312 of the fixing belt.

### (2.4.2) Fixing Belt

The fixing belt 31 includes: a base layer made of polyimide, stainless steel (SUS), electroformed nickel (Ni), and so forth; an elastic layer made of a material having high heat resistance; and a release layer provided with a release property, such as a fluorine tube and a fluorine coating. These layers are stacked in this order. Examples of the material having high heat resistance include silicone rubber and fluorine rubber.

### (2.4.3) Members Disposed Inside Fixing Belt

Inside the fixing belt 31, for example, a press pad 32, a guide member 33, a support member 34, a heating roller 35, a heater 36, a lubricant application member 37, and a bypass path 38 are disposed.

The fixing belt 31 is an aspect of the endless belt according to the present invention. The fixing belt 31 is wound around the press pad 32, the heating roller 35, and the guide member 33. The press pad 32 is in contact with the inner circumferential surface 311 of the fixing belt 31. The guide member 33 is in contact with the inner circumferential surface 311 of the fixing belt and guides the fixing belt 31.

When the heating roller 35 is biased by a spring or the like (not illustrated) in a direction separating from the press pad 32, a certain amount of tension acts on the fixing belt 31.

### (Press Pad)

The press pad 32 is an aspect of the elastic member according to the present invention. The press pad 32 is an elastic member disposed opposite the pressure roller 39, which is located outside the fixing belt 31, with the fixing belt 31 in between. The press pad 32 receives pressing force from the pressure roller 39 via the fixing belt 31.

The outer circumferential surface 391 of the pressure roller 39 and the outer circumferential surface 312 of the fixing belt 31 are in pressed contact with each other, so that the fixing nip 30 is formed between the fixing belt 31 and the pressure roller 39. The fixing nip 30 is an aspect of a nip portion according to the present invention. The pressing force of the pressure roller 39 applied to the press pad 32 via the fixing belt 31 at the fixing nip 30 corresponds to a nip pressure.

The press pad 32 includes a main body formed of resin (e.g., polyphenylene sulfide), metal, or the like and a sliding member (not illustrated) wound around the main body by about one round, for example.

The sliding member is a low-friction sheet. For example, the low friction sheet has a sliding surface (outer surface) that is made of a glass cloth as a base material and that is coated with a fluorine-based resin.

The sliding member may be made of any material that can reduce the sliding resistance against the fixing belt 31. For example, woven fabric of fluorine fiber, a fluororesin sheet, or glass coat may be used.

The sliding member may not be wound around the press pad 32.

### (Guide Member)

The guide member 33 is provided on the downstream side of the press pad 32 and on the upstream side of the heating roller 35 in the belt running direction. The guide member 33 is arranged near the press pad 32. The guide member 33 guides the fixing belt 31 that has just passed through the fixing nip 30 to the downstream in the belt running direction.

The press pad 32 and the guide member 33 are disposed inside the fixing belt 31 next to each other along the belt running direction. The press pad 32 and the guide member 33 do not rotate along with the rotating fixing belt 31.

The press pad 32 and the guide member 33 may be made of the same material. Examples of the material includes a resin, such as polyphenylene sulfide, polyimide, or a liquid crystal polymer. It is preferable that a material having excellent heat resistance is used.

Furthermore, the press pad 32 and the guide member 33 may be made of metal (e.g., aluminum or iron), ceramic, or a composite of metal and/or ceramic and silicone rubber, fluorine rubber, and so forth. The press pad 32 and the guide member 33 may be made of different materials.

### (Support Member)

The support member 34 is an aspect of the support body according to the present invention. The support member 34 is a support body that fixes and supports the press pad 32 and the guide member 33. It is preferable that the support member 34 is made of an aluminum alloy containing silicon and that the content of silicon in the aluminum alloy is within a range of 0.8 to 12.0% by mass. Thus, the adhesion between the press pad 32 and the support member 34 is improved, and the good conveyance performance of the recording medium can be maintained for a long time.

### (Heating Roller)

The heating roller 35 includes a cylindrical support body 35a and an elastic layer made of elastic members 35b formed on the support body 35a. The heating roller 35 also includes the heater 36 that applies heat to the heating roller 35 to heat the fixing belt 31. The rotation axis of the heating roller 35 is parallel to the Z-axis direction. Both ends of the heating roller 35 in the axis direction are rotatably supported by the frame.

[Cylindrical Support Body that Forms Heating Roller]

The cylindrical support body 35a is an aspect of the support body made of an aluminum alloy according to the present invention. It is preferable that the silicon content in the aluminum alloy is within a range of 0.8 to 12.0% by mass. As a result, the adhesion between the elastic member 35b and the support body 35a is improved, and the conveyance performance of the recording medium can be favorably maintained over a long time.

[Elastic Member that Constitutes Heating Roller]

The elastic member 35b constituting the heating roller 35 is an aspect of the elastic member according to the present invention. The elastic member 35b is preferably made of a material having high heat resistance, such as silicone rubber or fluorine rubber. The elastic member 35b is in close contact with the support body 35a.

### [Heater]

The heater 36 is a halogen heater elongated along the axial direction of the heating roller 35. The heater 36 is inserted in the inner space of the cylindrical heating roller 35. The heater 36 applies, to the heating roller 35, heat generated by power supply from a power source (not illustrated).

When the heater 36 is energized while the pressure roller 39 is driven to rotate, the heat generated by the heater 36 is transmitted from the heating roller 35 to the fixing belt 31 and reaches the fixing nip 30 by the rotating fixing belt 31. Thus, the heat of the heater 36 is supplied to the fixing nip 30.

### (Lubricant Application Member)

The lubricant application member 37 is made of a fibrous material (e.g., aramid fiber, fluorine fiber) or a porous material (e.g., a sponge) and is soaked with a lubricant. The lubricant application member 37 is fitted in a groove 339 formed in the guide member 33.

The upper surface of the lubricant application member 37 is in contact with the inner peripheral surface 311 of the fixing belt, so that the lubricant G is applied to the inner peripheral surface 311 of the fixing belt. The lubricant G reduces sliding resistance between the fixing belt 31 and the press pad 32 and thereby stabilizes the circulation of the fixing belt 31, as compared with a configuration without the lubricant G.

As the lubricant G, synthetic lubricating oil grease, such as silicone grease or fluorine grease, is used. The grease having a higher viscosity than oil is used as the lubricant G so that the lubricant G is less likely to leak out from both ends of the fixing belt 31 in the width direction.

The lubricant G has such a property that the viscosity decreases as the temperature increases. The lubricant G is not limited to grease but may be a different liquid material. The other material may be, for example, silicon-based or fluorine-based oil.

There may be a configuration without the lubricant application member 37. In the configuration without the lubricant application member 37, an appropriate amount of lubricant G is applied to the inner circumferential surface 311 of the fixing belt at the time of manufacturing or maintenance of the fixing section 12.

### (Bypass Path)

The bypass path 38 is disposed in a space 313 between the support member 34 and the heating roller 35 inside the fixing belt 31.

The bypass path 38 collects the lubricant G on the inner circumferential surface 311 of the fixing belt 31 at a first position 31α of the fixing belt 31. The bypass path 38 separates abrasion powder (not illustrated) from the collected lubricant G while allowing the collected lubricant G to pass through.

The bypass path 38 then returns the separated lubricant G to the inner circumferential surface 311 of the fixing belt at a second position 31β, which is provided upstream from the first position 31α (collection position) in the belt running direction.

The bypass path 38 includes: a flat plate-shaped sponge body 380 made of an open-cell sponge as an example of an elastic member having porous open cells; and plate-shaped support bodies 381 and 382 that sandwich the sponge body 380 from both sides in the thickness direction.

The sponge body 380 forms the bypass path of the lubricant G, collects the lubricant G on the inner circumferential surface 311 of the fixing belt, and separates and filters abrasion powder mixed in the lubricant G from the lubricant G while flowing the collected lubricant G through the open cells.

The upper edge part 385 of the sponge body 380 is in contact with the inner circumferential surface 311 of the fixing belt at the first position 31α in the belt running direction. The lower edge part 386 of the sponge body 380 is in contact with the inner circumferential surface 311 of the fixing belt at the second position 31β in the belt running direction.

Here, the first position 31α od the fixing belt 31 is provided downstream from the guide member 33 and upstream from the heating roller 35 in the belt running direction.

The second position 31β is provided upstream from the first position 31α in the belt running direction and lower than the first position 31α. Herein, the second position 31β is provided downstream from the heating roller 35 and upstream from the press pad 32 in the belt running direction.

The sponge body 380 and the support bodies 381, 382 that sandwich the sponge body 380 of the bypass path 38 are plate-like bodies elongated in the Z-axis direction.

The both ends of the support bodies 381 and 382 in the longitudinal direction thereof are fixed and supported by the frame. The upper edge 385 of the sponge body 380 is in contact with the inner circumferential surface 311 of the fixing belt 31 at the first position 31α.

Further, the support bodies 381 and 382 support a not-illustrated body portion of the sponge body 380 located between the upper edge 385 and the lower edge 386 such that the lower edge 386 is kept in contact with the inner circumferential surface 311 of the fixing belt 31 at the second position 31β.

Herein, the support bodies 381 and 382 are attached to part of both side surfaces of the not-illustrated main body portion that are in surface contact with the support bodies 381 and 382 with an adhesive, for example. The support bodies 381 and 382 are not in contact with the inner peripheral surface 311 of the fixing belt.

The plate surface of the sponge body 380 has a trapezoidal shape in a side view. The length of the upper edge 385 of the sponge body 380 in the belt width direction is substantially equal to the width of the fixing belt 31. Therefore, at the first position 31α, the entire upper edge 385 of the sponge body 380 from one end to the other end in the belt width direction is in contact with the inner circumferential surface 311 of the fixing belt.

On the other hand, the length of the lower edge 386 of the sponge body 380 in the belt width direction is shorter than the length of the upper edge 385 in the belt width direction and shorter than the width of the fixing belt 31.

Therefore, at the second position 31β, the following regions (1) and (2) of the inner circumferential surface 311 of the fixing belt are non-contact regions that are not in contact with the sponge body 380.

(1) The region from one end of the lower edge 386 of the sponge body 380 to one end of the fixing belt 31 in the belt width direction

(2) The region from the other end of the lower edge 386 of the sponge body 380 to the other end of the fixing belt 31 in the belt width direction

Such non-contact regions are provided to prevent leakage of the lubricant G to the outside of the fixing belt 31.

At the first position 31α, the lubricant G permeates into the sponge body 380 from the inner circumferential surface 311 of the fixing belt via the upper edge 385 of the sponge body 380. The permeating lubricant G at one end (the apparatus front side) or the other end (the back side) in the belt width direction descends along the side edge on the apparatus front side or the apparatus back side of the sponge body 380 while approaching the center in the belt width direction.

The lubricant G then comes out of the sponge body 380 from the lower edge 386 at the second position 31β, which is lower than the first position 31α, and returns to the inner peripheral surface 311 of the fixing belt. If the lubricant G that returned to the inner circumferential surface 311 of the fixing belt flows toward the ends (outer sides) of the fixing belt in the belt width direction, the lubricant G is likely to leak out of the fixing belt 31 if there is no non-contact region.

If the non-contact region is provided, even if the lubricant G flows outward in the belt width direction of the inner circumferential surface 311 of the fixing belt, the non-contact region allows the lubricant G to move toward the ends of the fixing belt in the belt width direction. Thus, the non-contact region can reduce the amount of the fixing belt 31 leaking outside the fixing belt 31.

The lubricant G that is returned to the inner circumferential surface 311 of the fixing belt 31 at the second position 31β reaches the press pad 32 as the fixing belt 31 circulates. While the lubricant G passes through the gap between the press pad 32 and the inner circumferential surface 311 of the fixing belt toward the fixing nip 30, the lubricant G gradually spreads toward both ends in the belt width direction by the contact pressure between the press pad 32 and the inner circumferential surface 311 of the fixing belt.

Thus, the lubricant G spreads to both ends in the belt width direction at the fixing nip 30 where the pressing force is greatest. Accordingly, the sliding resistance between the press pad 32 and the inner circumferential surface 311 of the fixing belt does not increase at both ends in the belt width direction.

### (2.5) Operation Section

The operation section 13 is disposed on the front of the apparatus where a user can easily operate the operation section 13. The operation section 13 includes, for example, keys for receiving printing conditions input by the user, such as the number of printed sheets and density.

### (2.6) Controller

The controller 14 controls operations of the image forming section 10, the conveyance section 11, the fixing section 12, the secondary transfer roller 18, and so forth to smoothly perform image forming operation (printing).

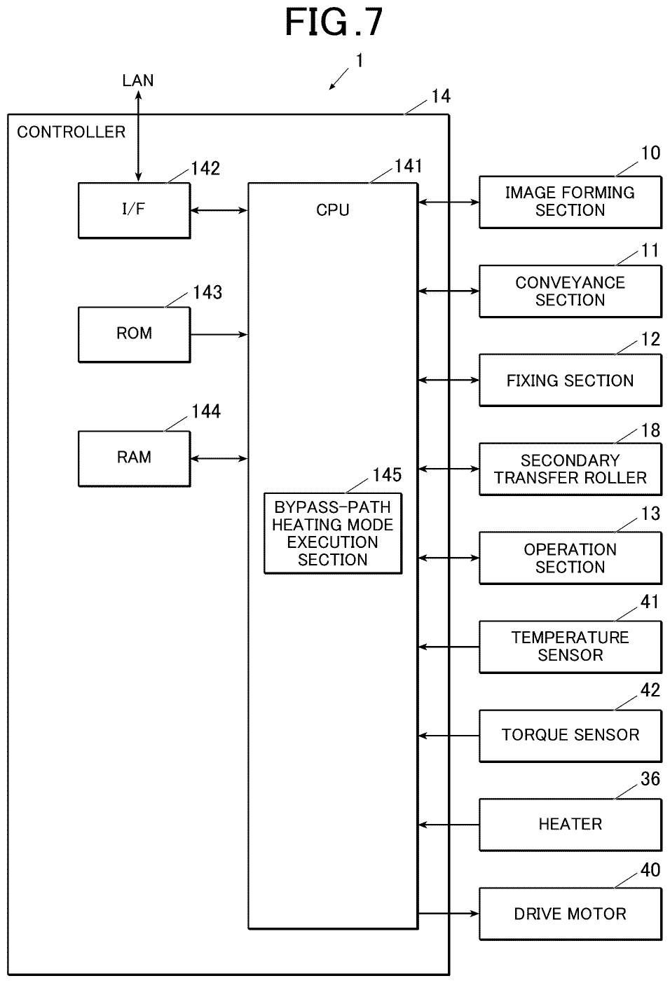

FIG. 7 is an example of a block diagram illustrating a configuration of the controller 14.

As illustrated in FIG. 7, the controller 14 includes a central processing unit (CPU) 141, a network I/F 142, a read only memory (ROM) 143, and a random access memory (RAM) 144.

These can communicate with each other.

The CPU 141 can also communicate with the image forming section 10, the conveyance section 11, the fixing section 12, and the operation section 13.

The network I/F 142 includes a communication control card, such as a LAN card, for example. The network I/F 142 receives print job data sent from an external terminal device (not illustrated) via a network (e.g., a LAN). The CPU 141 centrally controls the operations of the image forming section 10, the conveyance section 11, and the fixing section 12 to smoothly perform a print job, based on print job data received through the network I/F 142.

The ROM 143 stores beforehand a control program and so forth for executing a print job. The CPU 141 operates in accordance with the control program stored in the ROM 143.

The RAM 144 provides the CPU 141 with a work area when the CPU 141 executes a program.

The CPU 141 includes a bypass-path heating mode execution section 145. Further, the CPU 141 controls the temperature of the fixing belt 31, based on the detection result of the temperature sensor 41.

Further, the CPU 141 determines whether to execute the bypass-path heating mode, based on the detection result of the torque sensor 42. When determining to execute the bypass-path heating mode, the bypass-path heating mode execution section 145 executes the bypass-path heating mode.

The bypass-path heating mode is performed when the fixing is not performed. In the bypass-path heating mode, the bypass path 38 is heated until the temperature of the bypass path 38 rises higher than the temperature at the time of fixing, so that the viscosity of the lubricant G is decreased. The viscosity of the lubricant G increases owing to the abrasion powder generated by the sliding friction between the press pad 32 and the inner circumferential surface 311 of the fixing belt.

Specifically, owing to long-term sliding friction between the press pad 32 and the inner circumferential surface 311 of the fixing belt, the inner circumferential surface 311 and/or the press pad 32 is gradually worn away, and the amount of the abrasion powder generated by the abrasion increases. The abrasion powder is mixed into the lubricant G on the inner peripheral surface 311 of the fixing belt. The greater the amount of the mixed abrasion powder is, the higher the viscosity of the lubricant G is.

The more abrasion powder the lubricant G contains, the greater the viscosity of the lubricant G is, and the more lubricant G stays on the bypass path 38. Accordingly, the amount of the lubricant G supplied to the gap between the press pad 32 and the inner peripheral surface 311 of the fixing belt decreases. The sliding resistance between the press pad 32 and the inner circumferential surface 311 of the fixing belt increases, which may eventually affect stable running of the fixing belt 31.

Further, the greater the sliding resistance between the press pad 32 and the inner circumferential surface 311 of the fixing belt is, the greater the rotation load of the fixing belt 31 is. Further, the greater the rotation load of the fixing belt 31 is, the greater the rotation load of the pressure roller 39 that applies running-direction force to the fixing belt 31 is.

In view of the above, the rotational load of the pressure roller 39, namely the torque of the driving motor 40, is an indicator of the viscosity of the lubricant G, which increases due to the entering abrasion powder generated by the sliding friction between the press pad 32 and the inner peripheral surface 311 of the fixing belt.

The load torque of the drive motor 40 is detected by the torque sensor 42, and the bypass path heating mode is executed when the detected current torque detection value Tr1 (corresponding to the magnitude of the viscosity of the lubricant G) exceeds the threshold th1.

The bypass path 38 is heated by the heater 36. Specifically, the heater 36 is switched between on and off so that the temperature of the fixing belt 31 is maintained at a temperature T1 (e.g., 200° C.) higher than the fixing temperature T2 while the fixing belt 31 rotates. Hereinafter, the fixing temperature T1 is referred to as a first temperature T1, and the temperature T2 is referred to as a second temperature T2.

In the fixing, the temperature is controlled such that the temperature of the fixing belt 31 is maintained at the first temperature T1. On the other hand, in the bypass path heating mode, the temperature of the fixing belt 31 rises to the second temperature T2. The temperature of the sponge body 380 of the bypass path 38 disposed inside the fixing belt 31 also rises to a temperature higher than the temperature at the time of fixing.

When the temperature of the sponge body 380 rises higher than at the time of fixing, the viscosity of the lubricant G at the contact portion between the upper edge 385 of the sponge body 380 and the inner circumferential surface 311 of the fixing belt decreases, and the viscosity of the lubricant G inside the sponge body 380 decreases. Accordingly, the lubricant G becomes more fluid and is less likely to remain on the bypass path 38.

Thus, while the lubricant G flows downward by the gravity and capillary action through the bypass path formed of porous open cells from the inner circumferential surface 311 of the fixing belt to the lower edge 386 of the sponge body 380 via the upper edge 385 and the main body 387 of the sponge body 380, the abrasion powder mixed in the lubricant G is separated from the lubricant G in the sponge body 380 (filtration).

The lubricant G from which the abrasion powder has been separated comes out from the lower edge 386 of the sponge body 380 and is supplied to the inner circumferential surface 311 of the fixing belt.

The details of the processing of the print job and the processing of the bypass path heating mode may be the same as the embodiment described in the paragraph 0125 and subsequent paragraphs of Japanese Unexamined Patent Publication No. 2024-014253.

### 3. Developer

In the image formation, various known developers can be used. A two-component developer containing toner and carrier is preferable.

### (3.1) Toner for Developing Electrostatic Latent Image

### (3.1.1) Toner Base Particles

The two-component developer contains electrostatic latent image developing toner. The electrostatic latent image developing toner includes toner base particles. The toner base particles contain a binder resin and optionally contain a colorant, for example. Hereinafter, the “electrostatic latent image developing toner” may be simply referred to as the “toner”. The toner base particles may contain other components as needed, such as a release agent and a charge control agent.

In the present invention, the term “toner particles” refers to toner base particles to which an external additive is added, and an aggregate of the toner particles is referred to as “toner”.

In general, the toner base particles can be used as toner particles as they are. In the present invention, the toner base particles to which an external additive is added are used as toner particles. In the following description, the toner base particles and the toner particles are also simply referred to as “toner particles” when it is not necessary to distinguish them.

Details of the constituent materials of the toner base particles are described below.

### (Binder Resin)

As the binder resin constituting the toner base particles, a thermoplastic resin is preferably used. As such a binder resin, those generally used as a binder resin constituting a toner can be used without particular limitation.

### (External Additive)

An external additive is attached to the surfaces of the toner base particles for controlling fluidity and chargeability. As the external additive, known metal oxide particles can be used.

The surface of the metal oxide particles used as the external additive is preferably subjected to hydrophobic treatment using a known surface treatment agent, such as a coupling agent.

A lubricant can also be used as the external additive to further improve the cleaning performance and the transferability. Specific examples of the lubricant include salts of higher fatty acids such as zinc stearate and calcium stearate and boron nitride.

The amount of the external additive to be added is preferably in a range of 0.1 to 10% by mass, more preferably in a range of 1 to 5% by mass based on the total amount of the toner particles.

### (Release Agent)

The toner particles may contain a release agent. The release agent is not particularly limited to a specific type. Examples of the release agent include hydrocarbon-based waxes, such as polyethylene wax, oxidized polyethylene wax, polypropylene wax, oxidized polypropylene wax, and Fischer-Tropsch wax. Examples of the release agent further include known waxes, such as carnauba wax, fatty acid ester wax, sazol wax, rice wax, candelilla wax, jojoba oil wax, and beeswax. The content of the release agent in the toner particles is preferably in a range of 1 to 30 parts by mass, more preferably in a range of 5 to 20 parts by mass, with respect to 100 parts by mass of the binding resin.

### (Charge Control Agent)

The toner particles may contain a charge control agent. Examples of the charge control agent include a metal complex of a salicylic acid derivative with zinc or aluminum (salicylic acid metal complex). Examples of the charge control agent further include calixarene compounds, organoboron compounds, and fluorine-containing quaternary ammonium salt compounds. The content of the charge control agent in the toner particles is preferably in a range of 0.1 to 5 parts by mass with respect to 100 parts by mass of the binder resin.

### (Colorant)

The toner particles may contain a colorant to form a color toner. Examples of the colorant that can be used include known inorganic or organic coloring agents.

These colorants may be used singly or in combination of two or more, if necessary. When a colorant is used, the amount of the colorant to be added is preferably in a range of 1 to 30% by mass, more preferably in a range of 2 to 20% by mass based on the entire toner.

As the colorant, a surface-modified colorant may also be used. A known surface modifier can be used. Specifically, a silane coupling agent, a titanium coupling agent, or an aluminum coupling agent can be preferably used.

### (Others)

The volume average particle diameter of the toner particles is in the range of 3 to 10 μm. When the volume average particle diameter is less than 3 μm, the fluidity of the toner particles decreases, and the rise of the charge amount of the toner particles decreases. When the volume average particle diameter is greater than 10 μm, image quality deteriorates. The volume average particle diameter of the toner particles is preferably in a range of 3.5 to 6.5 μm. As the volume average particle diameter of the toner particles, specifically, a volume-based median diameter (D₅₀) measured by the following method is adopted.

The volume-based median diameter (D₅₀) of the toner particles can be measured and calculated using an apparatus in which a computer system for data processing is connected to “Multisizer 3 (manufactured by Beckman Coulter, Inc.)”.

The measurement procedure is as follows: 0.02 g of toner particles are wetted with 20 mL of a surfactant solution, and then subjected to ultrasonic dispersion for 1 minute to prepare a toner particle dispersion. As the surfactant solution, for example, a surfactant solution obtained by diluting a neutral detergent containing a surfactant component with pure water by 10 times can be used for the purpose of dispersing the toner particles.

The toner particle dispersion liquid is injected into a beaker containing ISOTONII (manufactured by Beckman Coulter, Inc.) in a sample stand with a pipette until the measured concentration falls within the range of 5% to 10%.

Next, the measuring device count is set to 25,000, and measurement is performed. The Multisizer 3 used has an aperture diameter of 100 μm.

The range in the measurement range of 1 to 30 μm is divided into 256 parts to calculate the frequency, and the particle diameter at which the volume integrated fraction is 50% from the largest is defined as the volume-based median diameter (D₅₀).

The volume average particle diameter of the toner particles can be controlled by controlling the concentration of the aggregating agent, the addition amount of the organic solvent, the fusion time, and so forth in the above production method.

The average circularity of the toner particles is preferably 0.98 or less, and more preferably 0.930 to 0.975 or less. Toner particles having an average circularity in such a range are more easily charged. The average circularity can be measured using, for example, a flow-type particle image analyzer “FPIA-3000” (manufactured by SYSMEX CORPORATION), and specifically, can be measured by the following method.

The toner particles are wetted with a surfactant solution and dispersed by being subjected to ultrasonic dispersion for one minute. Thereafter, using “FPIA-3000”, measurement is performed in an HPF (high magnification imaging) mode at an appropriate concentration of 3,000 to 10,000 HPF detections. Within this range, a reproducible measurement value can be obtained. The circularity is calculated by the following Expression (5).

$$Circularity = ( Perimeter of circle having the same projected area as particle image ) \text{} / ( Perimeter of particle projection image ) \qquad Expression ( 5 )$$

The average circularity is an arithmetic average value obtained by adding up the circularities of the respective particles and dividing the sum by the total number of the measured particles.

The average circularity of toner particles can be controlled by controlling the temperature, time, and the like during the aging treatment in the production method described above.

### (3.1.2) Method for Producing Toner

The toner base particles, namely the particles before an external additive is added, can be produced by a known toner production method. That is, examples of the toner production method include a so-called pulverization method in which toner base particles are prepared through kneading, pulverization, and classification steps, and a so-called polymerization method in which a polymerizable monomer is polymerized, and at the same time, particle formation is performed while controlling the shape and size. Toner particles are produced by adding an external additive and mixed with the toner base particles.

As a mixing device for the external additive, various known mixing devices such as a Turbula mixer, a Henschel mixer, a Nauter mixer, and a V-type mixer can be used. For example, when a Henschel mixer is used, the circumferential speed of the tip of the stirring blade is preferably set in a range of 30 to 80 m/s, and stirring and mixing are performed for about 10 to 30 minutes in a range of 20 to 50° C.

### (3.2) Carrier

One of main roles of the carrier included in the two-component developer is to be stirred and mixed with the toner in the developing box to provide the toner with a desired charge. Another role of the carrier is to serve as an electrode between the developing device and the photoreceptor and to function as a bearing substance (i.e., carrier) that transports the charged toner to an electrostatic latent image on the photoreceptor to form a toner image.

The carrier is held on the magnet roller by a magnetic force, acts on development, and returns to the developing box again. The carrier is then stirred and mixed with a new toner again and repeatedly used for a certain period.

To stably maintain desired image characteristics, it is naturally required that the characteristics of the carrier are stable while the carrier is used. The “image characteristics” include, for example, image density, fog, white spot, gradation, and resolution.

The carrier particles constituting the carrier are preferably formed of core material particles that are metal powder, such as iron, ferrite, or magnetic, and the surface of which is coated with a coating resin, as described below. The carrier particles may contain an internal additive such as a resistance adjuster, if necessary.

The surface of the core particle according to the present invention is preferably coated with a coating resin, and the coating resin preferably has a structure derived from (meth)acrylate. In this description, (meth)acryl means acryl or methacryl.

Examples of the compound having a structure derived from (meth)acrylate include a methacrylic acid ester compound, an acrylic acid ester compound, and an alicyclic (meth)acrylic acid ester compound. In particular, the alicyclic (meth)acrylic acid ester compound is more preferable. Since the alicyclic (meth)acrylic acid ester compound has high hydrophobicity, the moisture adsorption amount of the carrier particles is reduced under a high temperature and high humidity environment, so that a decrease in the charge amount is prevented.

The thickness of the resin coating layer is preferably in a range of 0.05 to 4 μm, more preferably in a range of 0.2 to 3 μm. When the thickness of the resin coating layer is within such a range, the chargeability and durability of the carrier particles can be improved.

The thickness of the resin coating layer can be determined by the following method.

A measurement sample is prepared by cutting the carrier particles along a plane passing through the center of the particles using a focused ion beam apparatus “SMI2050” (manufactured by Hitachi High-Tech Corp.). The cross section of the measurement sample is observed at a magnification of 5000 times using a transmission electron microscope “JEM-2010F” (manufactured by JEOL Ltd.), and the average value of the maximum and minimum thicknesses in that field of view is determined as the thickness of the resin coating layer. The number of fields of view for measurement is set to 5.

The coating resin preferably contains at least one of carbon black, magnesium oxide, and titanium dioxide as a resistance adjusting agent for adjusting the static resistance value of the carrier. Among these, carbon black, which easily disperses in the resin, is particularly preferable.

### EXAMPLES

Hereinafter, the present invention will be specifically described with reference to Examples, but the present invention is not limited thereto. In Examples, “part(s)” or “%” means “part(s) by mass” or “% by mass” unless otherwise specified.

### A. Preparation of Support Body

### (A.1) Preparation of Support body [A1-0]

A support body [A1-0] was Prepared by Using General Aluminum, Steel, and Stainless Steel as Wrought materials and by processing the materials into a shape like the support body 34 in FIG. 6. The wrought material having at least a silicon content of less than 0.5% by mass was used. Hereinafter, the shape like the support body 34 of FIG. 6 is referred to as a “U-shape” for convenience.

Whether the silicon content is less than 0.5% by mass was confirmed by qualitative and quantitative analysis using an X-ray fluorescence spectrometer “XRF-1700” (manufactured by Shimadzu Corp.) under the following measurement conditions.

### <Measurement Conditions>

Slit: standard
Attenuator: none
Analyzing crystal (Cu=LiF, Si=PET)
Detector (Cu=SC, Si=FPC)

### (A.2) Preparation of Support bodies [A1-1] to [A1-11]

Support bodies [A1-1] to [A1-11] were prepared by processing wrought materials made of silicon-containing aluminum alloys into the U-shape. The silicon and metal contents in the respective silicon-containing aluminum alloys were as shown in Table I. The content of metal elements in the respective aluminum alloys were confirmed by qualitative and quantitative analysis using an X-ray fluorescence analyzer “XRF-1700” (manufactured by Shimadzu Corp.) under the above measurement conditions.

In Table I, the metal content of the aluminum alloy of the wrought material used for the support body [A1-0] was not specifically measured and is therefore indicated as “-”. In Table I, “Si—Al wrought alloy” refers to an “aluminum alloy containing silicon”.

### (A.3) Preparation of Support Body [A2-0]

A support body [A2-0] was prepared by using general aluminum, steel, and stainless steel as wrought materials and by processing the materials into a hollow cylindrical shape. The wrought material having at least a silicon content of less than 0.5% by mass was used.

### (A.4) Production of Support Bodies [A2-1] to [A2-6]

Support bodies [A2-1] to [A2-6] were prepared by processing wrought materials made of silicon-containing aluminum alloys into a hollow cylindrical shape. The metal contents of the respective silicon-containing aluminum alloys were as shown in Table I.

In Table I, the metal content of the aluminum alloy of the wrought material used for the support body [A2-0] was not specifically measured and is therefore indicated as “-”.

In Table I, “Si—Al wrought alloy” refers to an “aluminum alloy containing silicon”.

TABLE I
SUPPORT BODY

| | | Si—Al ALLOY | | |
|---|---|---|---|---|
| | | | METAL CONTENT | |
| | | | [% BY MASS] | |
| No. | SHAPE | No. | Si | Cu |
| A1-0 | U-SHAPED | 0 | — | — |
| A1-1 | U-SHAPED | 1 | 7.5 | 0.1 |
| A1-2 | U-SHAPED | 2 | 5.0 | 0.1 |
| A1-3 | U-SHAPED | 3 | 10.0 | 0.2 |
| A1-4 | U-SHAPED | 4 | 12.0 | 1.1 |
| A1-5 | U-SHAPED | 5 | 1.0 | 0.2 |
| A1-6 | U-SHAPED | 6 | 6.0 | 2.0 |
| A1-7 | U-SHAPED | 7 | 7.4 | 5.0 |
| A1-8 | U-SHAPED | 8 | 0.8 | 0.2 |
| A1-9 | U-SHAPED | 9 | 0.6 | 0.1 |
| A1-10 | U-SHAPED | 10 | 13.0 | 1.0 |
| A1-11 | U-SHAPED | 11 | 18.0 | 6.0 |
| A2-0 | HOLLOW CYLINDER | 0 | — | — |
| A2-1 | HOLLOW CYLINDER | 1 | 7.5 | 0.1 |
| A2-2 | HOLLOW CYLINDER | 2 | 5.0 | 0.1 |
| A2-3 | HOLLOW CYLINDER | 3 | 10.0 | 0.2 |
| A2-4 | HOLLOW CYLINDER | 4 | 12.0 | 1.1 |
| A2-5 | HOLLOW CYLINDER | 8 | 0.8 | 0.2 |
| A2-6 | HOLLOW CYLINDER | 9 | 0.6 | 0.1 |
| B1-1 | HOLLOW CYLINDER | 1 | 7.5 | 0.1 |
| B1-2 | HOLLOW CYLINDER | 2 | 5.0 | 0.1 |
| B1-3 | HOLLOW CYLINDER | 3 | 10.0 | 0.2 |
| B1-4 | HOLLOW CYLINDER | 4 | 12.0 | 1.1 |
| B1-5 | HOLLOW CYLINDER | 5 | 1.0 | 0.2 |
| B1-6 | HOLLOW CYLINDER | 6 | 6.0 | 2.0 |
| B1-7 | HOLLOW CYLINDER | 7 | 7.4 | 5.0 |
| B1-8 | HOLLOW CYLINDER | 8 | 0.8 | 0.2 |
| B1-9 | HOLLOW CYLINDER | 9 | 0.6 | 0.1 |
| B1-10 | HOLLOW CYLINDER | 10 | 13.0 | 1.0 |
| B1-11 | HOLLOW CYLINDER | 11 | 18.0 | 6.0 |

### B. Preparation of Fixing Device

A fixing device component was prepared by forming an elastic layer to be in intimate contact with the support bodies listed in Table I. Thus, a fixing device was prepared.

In the following description, the position where the support body 34 is disposed in FIG. 6 is referred to as a position α1, and the position where the support body 35a is disposed is referred to as a position α2.

### (B.1) Preparation of Fixing Devices [1] to

As the fixing devices [1] to [11], fixing sections (fixing devices) having a configuration as illustrated in FIG. 6 were prepared.

### (Preparation of Fixing Device [1])

On the surface of the U-shaped support body [A1-1], an adhesive was applied. An LCO resin was molded into a shape corresponding to the fixing device component as the elastic layer (elastic member). The elastic member and the support body [A1-1] were brought into close contact with each other and disposed into the fixing section (fixing device) such that the support body [A1-1] was at the position α1 in the fixing section (fixing device).

Further, on the surface of the support body [A2-0] having a hollow cylindrical shape, silicone rubber was molded into a shape corresponding to the fixing device component as the elastic layer (elastic member). The elastic member and the support body [A2-0] were brought into close contact with each other and disposed into the fixing section (fixing device) such that the support body [A2-0] was at the position α2 in the fixing section (fixing device).

Thus, the fixing device [1] was prepared.

### (Preparation of Fixing Devices [2] to [11])

Fixing devices [2] to were prepared in the same manner as the fixing device [1] except that the U-shaped support [A1-1] and the hollow-cylindrical-shaped support body [A2-0] were changed as shown in Table II.

In Table II, the metal content of the aluminum alloy of the wrought material used for the support bodies [A1-0] and [A2-0] was not specifically measured and is therefore indicated as “-”. In Table II, “Si—Al alloy” refers to an “aluminum alloy containing silicon”.

### (B.2) Preparation of Fixing Devices [12] to [17]

As the fixing devices [12] to [17], fixing sections (fixing devices) having a configuration as illustrated in FIG. 6 were prepared.

### (Preparation of Fixing Device [12])

On the surface of the U-shaped support body [A1-0], an adhesive was applied. An LCO resin was molded into a shape corresponding to the fixing device component as the elastic layer (elastic member). The elastic member and the support body [A1-0] were brought into close contact with each other and disposed into the fixing section (fixing device) such that the support body [A1-0] was at the position α1 in the fixing section (fixing device).

Further, on the surface of the support body [A2-1] having a hollow cylindrical shape, silicone rubber was molded into a shape corresponding to the fixing device component as the elastic layer (elastic member). The elastic member and the support body [A2-1] were brought into close contact with each other and disposed into the fixing section (fixing device) such that the support body [A2-1] was at the position α2 in the fixing section (fixing device).

Thus, the fixing device was prepared.

### (Preparation of Fixing Devices [13] to [17])

Fixing devices [13] to [17] were prepared in the same manner as the fixing device except that the U-shaped support [A1-0] and the hollow-cylindrical-shaped support body [A2-1] were changed as shown in Table II.

In Table II, the metal content of the aluminum alloy of the wrought material used for the support bodies [A1-0] and [A2-0] was not specifically measured and is therefore indicated as “-”. The “Si—Al alloy wrought material” in Table II represents the “aluminum alloy containing silicon”.

TABLE II
FIXING DEVICE

| | SUPPORT BODY | | | | | |
|---|---|---|---|---|---|---|
| | | | Si—Al ALLOY | | | |
| | | | | METAL CONTENT | | |
| | | | | [% BY MASS] | | SET |
| No. | No. | SHAPE | No. | Si | Cu | POSITION |
| 1 | A1-1 | U-SHAPED | 1 | 7.5 | 0.1 | α1 |
| | A2-0 | HOLLOW CYLINDER | 0 | — | | α2 |
| 2 | A1-2 | U-SHAPED | 2 | 5.0 | 0.1 | α1 |
| | A2-0 | HOLLOW CYLINDER | 0 | — | | α2 |
| 3 | A1-3 | U-SHAPED | 3 | 10.0 | 0.2 | α1 |
| | A2-0 | HOLLOW CYLINDER | 0 | — | | α2 |
| 4 | A1-4 | U-SHAPED | 4 | 12.0 | 1.1 | α1 |
| | A2-0 | HOLLOW CYLINDER | 0 | — | | α2 |
| 5 | A1-5 | U-SHAPED | 5 | 1.0 | 0.2 | α1 |
| | A2-0 | HOLLOW CYLINDER | 0 | — | | α2 |
| 6 | A1-6 | U-SHAPED | 6 | 6.0 | 2.0 | α1 |
| | A2-0 | HOLLOW CYLINDER | 0 | — | | α2 |
| 7 | A1-7 | U-SHAPED | 7 | 7.4 | 5.0 | α1 |
| | A2-0 | HOLLOW CYLINDER | 0 | — | | α2 |
| 8 | A1-8 | U-SHAPED | 8 | 0.8 | 0.2 | α1 |
| | A2-0 | HOLLOW CYLINDER | 0 | — | | α2 |
| 9 | A1-9 | U-SHAPED | 9 | 0.6 | 0.1 | α1 |
| | A2-0 | HOLLOW CYLINDER | 0 | — | | α2 |
| 10 | A1-10 | U-SHAPED | 10 | 13.0 | 1.0 | α1 |
| | A2-0 | HOLLOW CYLINDER | 0 | — | | α2 |
| 11 | A1-11 | U-SHAPED | 11 | 18.0 | 6.0 | α1 |
| | A2-0 | HOLLOW CYLINDER | 0 | — | | α2 |
| 12 | A1-0 | U-SHAPED | 0 | — | | α1 |
| | A2-1 | HOLLOW CYLINDER | 1 | 7.5 | 0.1 | α2 |
| 13 | A1-0 | U-SHAPED | 0 | — | | α1 |
| | A2-2 | HOLLOW CYLINDER | 2 | 5.0 | 0.1 | α2 |
| 14 | A1-0 | U-SHAPED | 0 | — | | α1 |
| | A2-3 | HOLLOW CYLINDER | 3 | 10.0 | 0.2 | α2 |
| 15 | A1-0 | U-SHAPED | 0 | — | | α1 |
| | A2-4 | HOLLOW CYLINDER | 4 | 12.0 | 1.1 | α2 |
| 16 | A1-0 | U-SHAPED | 0 | — | | α1 |
| | A2-5 | HOLLOW CYLINDER | 8 | 0.8 | 0.2 | α2 |
| 17 | A1-0 | U-SHAPED | 0 | — | | α1 |
| | A2-6 | HOLLOW CYLINDER | 9 | 0.6 | 0.1 | α2 |

### (B.3) Preparation of Fixing Devices [18] to [28]

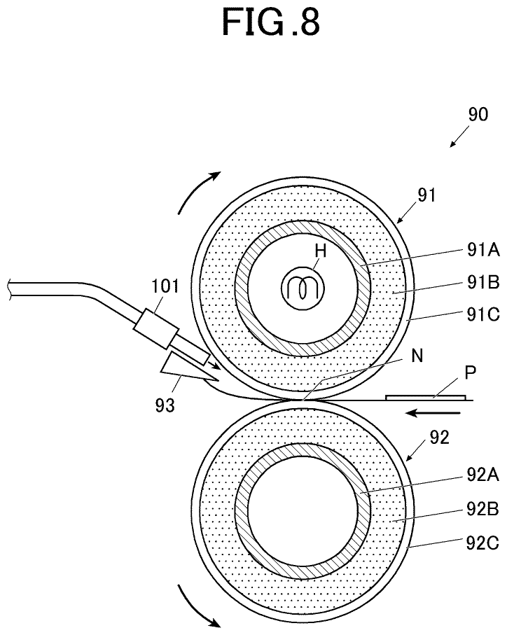

As the fixing devices [18] to [28], fixing sections (fixing devices) having a configuration as illustrated in FIG. 8 were prepared. FIG. 8 is an example of a schematic cross-sectional view illustrating a configuration of the fixing section. Hereinafter, FIG. 8 is described before the production of the fixing device is described.

In FIG. 8, the fixing device 90 includes a heating roller 91 that is heated by a halogen heater H and a pressure roller 92 that pressurizes the heating roller 91 from below.

The heating roller 91 includes a halogen heater H built in the center, a core metal 91A formed in a hollow cylindrical shape, a heat-resistant elastic layer 91B, and a release layer 91B that covers the elastic layer 91C with a tube.

In the following description, the elastic member refers to not only the above-described elastic layer 91B but also a combination of the elastic layer 91B and the release layer 91C.

The core metal 91A is made of an aluminum alloy. The elastic layer 91B is made of heat-resistant silicone rubber. The release layer 91C is made of fluororesin, such as perfluoroalkoxy (PFA) or polytetrafluoroethylene (PTFE).

The pressure roller 92 includes a cylindrical core metal 92A formed of stainless steel or the like, an elastic layer 92B formed of a foamed body of silicon rubber and positioned on the outer circumferential surface of the core metal 92A, and a releasing layer 92C formed of a PFA tube and so forth and covering the outer circumferential surface of the elastic layer 92B.

The pressure roller 92 is urged by an urging member (not illustrated) to press the heating roller 91 from below.

With the above-described configuration, when the heating roller 91 heated by the halogen heater H and driven by a motor (not illustrated) rotates clockwise, the pressure roller 92 rotates counterclockwise.

The recording medium P on which the toner image has been formed by the image forming apparatus is nipped and conveyed in the nip portion N, which is formed by the heating roller 91 and the pressure roller 92 and is heated and pressurized. Thus, the toner image on the recording medium P is fixed.

To prevent the toner image on the recording medium P from being pressure-bonded to the surface of the heating roller 91 and prevent the recording medium P from being wound around the heating roller 91 due to the stickiness of the softened toner, an air nozzle 101 that ejects compressed air is provided on the sheet ejection side of the recording medium P with respect to the nip portion N. The compressed air is jetted to the heating roller 91 to peel off the leading end of the recording medium P wound around the heating roller 91 by the wind pressure of the air.

Further, the guide member 93 protrudes in the direction of the nip portion N from the air nozzle 101, so that the peeled recording medium P is conveyed along the guide member 93 without coming into contact with the air nozzle 101.

### (Preparation of Fixing Device [18])

The fixing roller 91 was prepared as follows: the support body 91A was the hollow-cylindrical-shaped support body [B1-1], and the elastic layer 91B made of silicone rubber was formed on the surface of the support body [B1-1]. The prepared fixing roller 91 was incorporated into the fixing section (fixing device).

Thus, the fixing device was prepared.

### (Preparation of Fixing Devices [19] to [28])

Fixing devices [19] to [28] were prepared in the same manner as the fixing device [18] except that the hollow-cylindrical-shaped support body [B1-1] was changed as shown in Table III.

The “Si—Al alloy” in Table III means “aluminum alloy containing silicon”.

TABLE III
FIXING DEVICE

| | SUPPORT BODY | | | | |
|---|---|---|---|---|---|
| | | | Si—Al ALLOY | | |
| | | | | METAL CONTENT | |
| | | | | [% BY MASS] | |
| No. | No. | SHAPE | No. | Si | Cu |
| 18 | B1-1 | HOLLOW CYLINDER | 1 | 7.5 | 0.1 |
| 19 | B1-2 | HOLLOW CYLINDER | 2 | 5.0 | 0.1 |
| 20 | B1-3 | HOLLOW CYLINDER | 3 | 10.0 | 0.2 |
| 21 | B1-4 | HOLLOW CYLINDER | 4 | 12.0 | 1.1 |
| 22 | B1-5 | HOLLOW CYLINDER | 5 | 1.0 | 0.2 |
| 23 | B1-6 | HOLLOW CYLINDER | 6 | 6.0 | 2.0 |
| 24 | B1-7 | HOLLOW CYLINDER | 7 | 7.4 | 5.0 |
| 25 | B1-8 | HOLLOW CYLINDER | 8 | 0.8 | 0.2 |
| 26 | B1-9 | HOLLOW CYLINDER | 9 | 0.6 | 0.1 |
| 27 | B1-10 | HOLLOW CYLINDER | 10 | 13.0 | 1.0 |
| 28 | B1-11 | HOLLOW CYLINDER | 11 | 18.0 | 6.0 |

### C. Preparation of Toner 1

### (C.1) Preparation of Amorphous Polyester Particle Dispersion 1 (a1)

Into a reaction vessel equipped with a stirrer, a thermometer, a condenser and a nitrogen gas introducing tube, the following monomer [1] and 0.25 parts by mass of “tin dioctanoate” with respect to 100 parts by mass of the total of the following monomer [1] were charged.

### <Monomer [1]>

Bisphenol A ethylene oxide 2.2 molar adduct: 40 parts by mole
Bisphenol A propylene oxide 2.2 molar adduct: 60 parts by mole
Dimethyl terephthalate: 60 parts by mole
Dodecenyl succinic anhydride: 20 parts by mole

Under a nitrogen gas stream, the mixture was reacted in the reaction vessel at 235° C. for 6 hours. Thereafter, the temperature in the reaction vessel was lowered to 200° C., 15 parts by mole of dimethyl fumarate and 5 parts by mole of trimellitic anhydride were added to the reaction vessel, and the mixture was allowed to react in the reaction vessel for 1 hour.

The temperature in the reaction vessel was increased to 220° C. over 5 hours, and polymerization was performed under 10 kPa pressures until a desired molecular weight was reached, to produce a pale-yellow transparent amorphous polyester (A1). The amorphous polyester (A1) had a weight average molecular weight (Mw) of 35000, a number average molecular weight (Mn) of 8000, and a glass transition temperature (Tg) of 56° C.

Next, the amorphous polyester (A1) and the following mixed solution [2] in the following amounts were placed in a separable flask, and were thoroughly mixed and dissolved.
Amorphous polyester [A1]: 200.0 parts by mass

### <Mixed Solution [2]>

Methyl ethyl ketone: 100.0 parts by mass
Isopropyl alcohol: 35.0 parts by mass
10% by mass aqueous ammonia solution: 7.0 parts by mass

Thereafter, while the inside of the separable flask was heated and stirred at 40° C., ion exchanged water was added dropwise thereto at a liquid feeding rate of 8 g/min by using a liquid feeding pump. When the amount of the ion exchanged water fed reached 580 parts by mass, the dropwise addition of the ion exchanged water was stopped. Thereafter, the solvent was removed under reduced pressure to prepare a dispersion (a) of amorphous polyester particles.

Ion exchanged water was added to the dispersion (a) to adjust the solids content to be 25% by mass, thereby preparing an amorphous polyester particle dispersion (a1). The volume-based median diameter (d50) of the amorphous polyester particles contained in the amorphous polyester particle dispersion (a1) was measured using Microtrac UPA-150 (manufactured by Nikkiso Co., Ltd.) and found to be 156 nm.

### (C.2) Preparation of Amorphous Vinyl Resin Particle Dispersion (b1)

Into a 5 L reaction vessel equipped with a stirring device, a temperature sensor, a cooling tube, and a nitrogen introduction device, 5.0 parts by mass of an anionic surfactant (DOWFAX manufactured by The Dow Chemical Company) and 2500 parts by mass of ion exchanged water were charged, the temperature in the reaction vessel was increased to 75° C. while stirring at a 230 rpm stirring speed under a nitrogen gas stream. Next, a solution in which 18.0 parts by mass of potassium persulfate (KPS) was dissolved in 342 parts by mass of ion exchange water was added into the above reaction vessel, and the liquid temperature was set to 75° C.

Furthermore, a mixed liquid containing the following monomer [3] was added dropwise to the above reaction vessel in the following amount for 2 hours.

### <Monomer [3]>

Styrene (St): 903.0 parts by mass
n-Butyl acrylate (BA): 282.0 parts by mass
Acrylic acid (AA): 12.0 parts by mass
1,10-Decanediol diacrylate: 3.0 parts by mass
Dodecanethiol: 8.1 parts by mass

After the completion of the dropwise addition, the mixture was heated and stirred at 75° C. for 2 hours to cause polymerization, thereby preparing an amorphous vinyl resin particle dispersion (b).

Ion exchanged water was added to the dispersion (b) to adjust the solids content to be 25% by mass, thereby preparing an amorphous vinyl resin particle dispersion (b1). The “amorphous vinyl resin” contained in the amorphous vinyl resin particle dispersion (b1) is referred to as “amorphous vinyl resin (B1)”.

The volume-based median diameter (d50) of the amorphous vinyl resin particles contained in the amorphous vinyl resin particle dispersion (b1) was measured using Microtrac UPA-150 (manufactured by Nikkiso Co., Ltd.) and found to be 160 nm.

The amorphous vinyl resin (B1) had a glass-transition temperature (Tg) of 52° C., a weight average molecular weight (Mw) of 38000, and a number average molecular weight (Mn) of 15000.

### (C.3) Preparation of Crystalline Polyester Particle Dispersion (c1)

The following monomers [4] were charged into a reaction vessel equipped with a stirrer, a thermometer, a condenser and a nitrogen gas introduction tube in the following amounts, and the atmosphere in the reaction vessel was replaced by dry nitrogen gas.

### <Monomers [4]>

Decanedioic acid: 50 parts by mole
1,6-Hexanediol: 50 parts by mole

Next, titanium tetrabutoxide (Ti(O-n-Bu)₄) was charged in an amount of 0.25 parts by mass with respect to 100 parts by mass of the total of the monomers [4]. Under a nitrogen gas stream, the temperature in the reaction vessel was set to 170° C., and the mixture was stirred and reacted for 3 hours.

Thereafter, the temperature in the reaction vessel was further increased to 210° C. over 1 hour, the pressure in the reaction vessel was reduced to 3 kPa, and the mixture was stirred and reacted under reduced pressure for 13 hours. Through the above, crystalline polyester (C1) was obtained. The crystalline polyester (C1) had a weight average molecular weight (Mw) of 25000, a number average molecular weight (Mn) of 8500, and a melting point of 71.8° C.

Next, the crystalline polyester (C1) and a mixed solution composed of the following mixed solution [5] were placed in a separable flask in the following amounts, thoroughly mixed and dissolved at 60° C., and then 8 parts by mass of a 10% by mass aqueous ammonium solution was added dropwise.

Crystalline polyester (C1): 200 parts by mass

### <Mixed Solution [5]>

Methyl ethyl ketone: 120 parts by mass
Isopropyl alcohol: 30 parts by mass

Thereafter, the heating temperature was raised to 67° C., and the solution was added dropwise at a solution sending rate of 8 g/minute using an ion exchange water solution sending pump while stirring. When the amount of the ion exchanged water fed reached 580 parts by mass, the dropwise addition of the ion exchanged water was stopped.

Thereafter, the solvent was removed under reduced pressure to prepare a crystalline polyester particle dispersion (c). Ion-exchanged water was added to the dispersion (c) to adjust the solids content to 25% by mass, thereby preparing a crystalline polyester dispersion (c1). The volume-based median diameter (d50) of the crystalline polyester particles contained in the crystalline polyester particle dispersion (c1) was measured using Microtrac UPA-150 (manufactured by Nikkiso Co., Ltd.) and found to be 198 nm.

### (C.4) Preparation of Release Agent Particle Dispersion (W1)

The following release agent, surfactant, and ion exchanged water were mixed in the following amounts, and the release agent was dissolved at an internal liquid temperature of 120° C. using a pressure discharge-type homogenizer (Gaulin homogenizer, manufactured by Gaulin).

“FNP0090” (release agent): 270 parts by mass
“NEOGEN RK” (surfactant): 13.5 parts by mass
Ion exchanged water: 21.6 parts by mass

The release agent “FNP0090” (manufactured by NIPPON SEIRO CO., LTD.) is a paraffin-based wax and has a melting point of 89° C.

The surfactant “NEOGEN RK” (manufactured by DKS Co., Ltd) is an anionic surfactant.

Thereafter, the mixture was dispersed at dispersion pressures of 5 MPa for 120 minutes and then 40 MPa for 360 minutes and cooled to obtain a dispersion (w). Furthermore, ion exchanged water was added to adjust the dispersion (w) so that the solid content was 20%, and the obtained dispersion was set as a release agent particle dispersion (W1). The volume average particle diameter of the particles in the release agent particle dispersion (W1) was 215 nm.

### (C.5) Preparation of Black Colorant Particle Dispersion 1

The following resistance adjusters, surfactants, and ion-exchanged water in the following amounts were mixed, and pre-dispersed for 10 minutes using a homogeniser (ULTRA-TURRAX T50, manufactured by Ika-Werke GmbH & Co. KG).

“REGAL (registered trademark) 330” (resistance adjuster): 100 parts
by mass
“NEOGEN SC” (surfactant): 15 parts by mass
Ion exchanged water: 400 parts by mass

The above resistance modifier is carbon black (manufactured by Cabot Corp.).

Further, the above surfactant is an anionic surfactant (manufactured by DKS Co., Ltd.).

Thereafter, a dispersion treatment was performed for 30 minutes at a pressure of 245 MPa by using a high-pressure impact type disperser ULTIMIZER (manufactured by Sugino Machine Limited) to obtain an aqueous dispersion of black colorant particles. Ion-exchanged water was added to the aqueous dispersion liquid of the black colorant particles to adjust the solid content to 15% by mass, and this was set as a black colorant particle dispersion liquid (1). The volume-based median diameter (d50) of the colorant particles in the black colorant particle dispersion (1) was measured using Microtrac UPA-150 (manufactured by Nikkiso Co., Ltd.) and found to be 110 nm.

### (C.6) Preparation of Toner Base Particle (1)

### (Aggregation-Fusion Process and Aging Process)

To a 4-liter reaction vessel equipped with a thermometer, a pH meter, and a stirrer, the dispersions prepared in (D.1) to (D.5) above, a surfactant, and ion exchanged water were charged in the following amounts, and the pH was adjusted to 3.0 by adding 1.0% nitric acid at a temperature of 25° C. to obtain a dispersion of raw materials.

Amorphous polyester particle dispersion (a1): 1008 parts by mass
Amorphous vinyl resin particle dispersion (b1): 32 parts by mass
Crystalline polyester particle dispersion (c1): 160 parts by mass
Release agent particle dispersion (W1): 160 parts by mass
Black colorant particle dispersion (1): 187 parts by mass
“Dowfax2A1” (surfactant): 40 parts by mass
Ion exchanged water: 1500 parts by mass

Note that the above-described surfactant is an anionic surfactant.

Thereafter, 100 parts by mass of an aggregating agent is added dropwise over 30 minutes while dispersing at 3000 rpm using a homogenizer “ULTRA-TURRAX T50” (manufactured by Ika-Werke GmbH & Co. KG). As the aggregating agent, an aqueous solution of aluminum sulfate having a concentration of 2% was used.

After the completion of the dropwise addition of the aggregating agent, the mixture was stirred for 10 minutes to sufficiently mix the dispersion of raw materials and the aggregating agent. Thereafter, a stirrer and a mantle heater were installed in the reaction vessel.

While the rotation speed of the stirrer was adjusted so that the slurry was sufficiently stirred, the temperature increase rate was set to 0.2° C./min until the temperature in the reaction vessel became 40° C.

After the temperature in the reaction vessel higher than 40° C., the temperature was increased at the temperature increase rate of 0.05° C./min, and the particle diameter was measured every 10 minutes using “Coulter Multisizer 3” (aperture diameter 100 μm, manufactured by Beckman Coulter, Inc.).

When the volume-based median diameter of the particles in the dispersion of the raw materials reached 3.9 μm, the temperature was maintained, and a mixed liquid of the following amorphous polyester particle dispersion (a1) and a surfactant, which had been mixed in advance, was charged into the reaction vessel over 20 minutes.

### <Mixed Liquid>

Amorphous polyester particle dispersion (a1): 400 parts by mass
“Dowfax2A1” (surfactant): 15 parts by mass

Note that the above-described surfactant is an anionic surfactant.

Next, the inside of the reaction vessel was maintained at 50° C. for 30 minutes, and then 8 parts by mass of a 20% solution of ethylenediaminetetraacetic acid (EDTA) was added to the reaction vessel. Thereafter, 1 mol/L of an aqueous sodium hydroxide solution was added to the reaction vessel, and the pH of the raw material dispersion in the reaction vessel was controlled to 9.0. Thereafter, the temperature was increased to 85° C. at a temperature increase rate of 1° C./min while the pH was adjusted to 9.0 with each 5° C. increase, and then the temperature was maintained at 85° C.

### (Cooling Process)

Thereafter, using “FPIA-3000”, when the shape factor reached 0.970, the mixture was cooled at a temperature decrease rate of 10° C./min to prepare a toner base particle dispersion (1).

### (Filtration-Washing Process and Drying Process)

Thereafter, the toner base particle dispersion (1) was filtered, thoroughly washed with ion exchanged water, and dried at 40° C. to produce toner base particles (1). The produced toner base particles (1) had a volume-based median diameter of 4.0 μm and an average circularity of 0.971.

### (C.7) Addition of External Additive

To the toner base particles (1) prepared above, the following external additive was added in the following amounts and mixed using a Henschel mixer (manufactured by Mitsuimiikekakouki, Inc.).

### <External Additive>

Hydrophobic silica (number average primary particle size: 12 nm, degree
of hydrophobization: 68): 1.0% by mass
Hydrophobic titanium oxide (number average primary particle size: 20 nm,
hydrophobicity: 64): 1.5% by mass

Thereafter, coarse particles were removed using a sieve with an opening of 45 μm to prepare “toner 1”.

### D. Preparation of Carrier and Developer

### (D.1) Preparation of Coating Resin

To an aqueous solution of 0.3% by mass sodium benzenesulfonate, each monomer of cyclohexyl methacrylate/styrene was added at a mass ratio of (50:50).

Potassium peroxodisulfate in an amount corresponding to 0.5% by mass of the total amount of the respective monomers was added to perform emulsion polymerization, thereby preparing coating resin 1. The weight average molecular weight of the coating resin 1 measured by a known measurement device was 500,000.

### (D.2) Preparation of Carrier 1

Carrier 1 was produced according to the following procedure.

Mn—Mg—Sr based “ferrite particles” having a volume-average particle diameter of 35 μm and saturation magnetizations of 61 A·m2/kg were prepared. The ferrite particles had a volume resistance value of 4.5×10⁷ Ω·cm.

To a high-speed mixer equipped with a stirring blade, 100 parts by mass of the “core material particles” prepared above and 3.5 parts by mass of the “coating resin 1” were charged. At this time, the materials were mixed and stirred at 22° C. for 15 minutes under conditions in which the circumferential speed of the horizontal rotary wing was 8 m/sec. The mixture was then mixed at 120° C. for 50 minutes to produce carrier 1 having a resin coating layer on the surface of the core material particle by the action of mechanical impact force (mechanochemical method). The core material exposed area ratio of the carrier 1 was 10%, and the volume resistance values were 10¹² Ω·cm.

### (D.3) Preparation of Developer

The carrier 1 and the toner 1 were charged into a V-type mixer in the following amounts and mixed for 5 minutes in a normal temperature and normal humidity environment to prepare a developer 1.

Carrier 1: 100 parts by mass
Toner 1: 6 parts by mass

### E. Evaluation of Conveyance Performance

### (E.1) Examples 1 to 11 and Comparative Examples 1 to 6

The fixing devices having combinations shown in Table IV were appropriately prepared and mounted on an image forming apparatus “bizhub c360i” manufactured by Konica Minolta, Inc. The developer 1 was loaded.

Under conditions of a temperature of 23° C. and 50% RH, long-term printing was performed on 300,000 sheets of recording media at a coverage of 5%.

After the long-term printing, printing was performed on 10 sheets at a coverage of 20% using the following four types of recording media <1> to <4>.

### <Types of Recording Media >

<1> NPI High-Quality Paper (Basis Weight: 64 g/m², A4 Size)
<2> Plain paper manufactured by Mondi (basis weight: 90 g/m², A4 size)
<3> OK Top Coat+T (basis weight: 73.3 g/m², A4 size) manufactured by Oji Paper Co., Ltd.
<4> OK Top Coat+Y (basis weight: 73.3 g/m², A4 size) manufactured by Oji Paper Co., Ltd.
Thereafter, whether paper wrinkle, image peeling, and sheet jam occurred was visually checked and evaluated according to the following evaluation criteria.

### (Evaluation Criteria)

A: Neither paper jam nor paper wrinkling occurred, and no image peeling was observed in any paper type.
B: Paper wrinkle and image peeling occurred in one paper type.
C: Paper wrinkling and image peeling occurred in two paper types.
D: Paper wrinkling and image peeling occurred in three or more paper types, or a sheet jam occurred.

TABLE IV

| | FIXING DEVICE | | | | | | | |
|---|---|---|---|---|---|---|---|---|
| | | SUPPORT BODY | | | | | | |
| | | | | Si—Al ALLOY | | | | |
| EXAMPLE | | | | | METAL | | | EVALUATION |
| OR | | | | | CONTENT | | SET | OF |
| COMPARATIVE | | | | | [% BY MASS] | | POSI- | CONVEYANCE |
| EXAMPLE | No. | No. | SHAPE | No. | Si | Cu | TION | PERFORMANCE |
| EXAMPLE 1 | 1 | A1-1 | U-SHAPED | 1 | 7.5 | 0.1 | α1 | A |
| | | A2-0 | HOLLOW CYLINDER | 0 | — | | α2 | |
| EXAMPLE 2 | 2 | A1-2 | U-SHAPED | 2 | 5.0 | 0.1 | α1 | A |
| | | A2-0 | HOLLOW CYLINDER | 0 | — | | α2 | |
| EXAMPLE 3 | 3 | A1-3 | U-SHAPED | 3 | 10.0 | 0.2 | α1 | A |
| | | A2-0 | HOLLOW CYLINDER | 0 | — | | α2 | |
| EXAMPLE 4 | 4 | A1-4 | U-SHAPED | 4 | 12.0 | 1.1 | α1 | B |
| | | A2-0 | HOLLOW CYLINDER | 0 | — | | α2 | |
| EXAMPLE 5 | 5 | A1-5 | U-SHAPED | 5 | 1.0 | 0.2 | α1 | B |
| | | A2-0 | HOLLOW CYLINDER | 0 | — | | α2 | |
| EXAMPLE 6 | 6 | A1-6 | U-SHAPED | 0 | 6.0 | 2.0 | α1 | C |
| | | A2-0 | HOLLOW CYLINDER | 0 | — | | α2 | |
| EXAMPLE 7 | 7 | A1-7 | U-SHAPED | 7 | 7.4 | 5.0 | α1 | C |
| | | A2-0 | HOLLOW CYLINDER | 0 | — | | α2 | |
| EXAMPLE 8 | 12 | A1-0 | U-SHAPED | 0 | — | | α1 | A |
| | | A2-1 | HOLLOW CYLINDER | 1 | 7.5 | 0.1 | α2 | |
| EXAMPLE 9 | 13 | A1-0 | U-SHAPED | 0 | — | | α1 | A |
| | | A2-2 | HOLLOW CYLINDER | 2 | 5.0 | 0.1 | α2 | |
| EXAMPLE 10 | 14 | A1-0 | U-SHAPED | 0 | — | | α1 | A |
| | | A2-3 | HOLLOW CYLINDER | 3 | 10.0 | 0.2 | α2 | |
| EXAMPLE 11 | 15 | A1-0 | U-SHAPED | 0 | — | | α1 | B |
| | | A2-4 | HOLLOW CYLINDER | 4 | 12.0 | 1.1 | α2 | |
| COMPARATIVE | 8 | A1-8 | U-SHAPED | 8 | 0.8 | 0.2 | α1 | D |
| EXAMPLE 1 | | A2-0 | HOLLOW CYLINDER | 0 | — | | α2 | |
| COMPARATIVE | 9 | A1-9 | U-SHAPED | 9 | 0.6 | 0.1 | α1 | D |
| EXAMPLE 2 | | A2-0 | HOLLOW CYLINDER | 0 | — | | α2 | |
| COMPARATIVE | 10 | A1-10 | U-SHAPED | 10 | 13.0 | 1.0 | α1 | D |
| EXAMPLE 3 | | A2-0 | HOLLOW CYLINDER | 0 | — | | α2 | |
| COMPARATIVE | 11 | A1-11 | U-SHAPED | 11 | 18.0 | 6.0 | α1 | D |
| EXAMPLE 4 | | A2-0 | HOLLOW CYLINDER | 0 | — | | α2 | |
| COMPARATIVE | 16 | A1-0 | U-SHAPED | 0 | — | | α1 | D |
| EXAMPLE 5 | | A2-5 | HOLLOW CYLINDER | 8 | 0.8 | 0.2 | α2 | |
| COMPARATIVE | 17 | A1-0 | U-SHAPED | 0 | — | | α1 | D |
| EXAMPLE 6 | | A2-6 | HOLLOW CYLINDER | 9 | 0.6 | 0.1 | α2 | |

### (E.2) Examples 12 to 18 and Comparative Examples 7 to 10

The fixing devices having the combinations in Table V were appropriately prepared and mounted on an image forming apparatus “Accurio Press C4070” manufactured by Konica Minolta, Inc. described in FIG. 1 of JP2007-240921A. The developer 1 was loaded.

Under conditions of a temperature of 23° C. and 50% RH, long-term printing was performed on 300,000 sheets of recording media at a coverage of 5%.

After the long-term printing, printing was performed on 10 sheets at a coverage of 20% using the following four types of recording media.

### <Type of Recording Media >

<1> NPI high-quality paper (basis weight: 64 g/m², A4 size)
<2> Plain paper manufactured by Mondi (basis weight: 90 g/m², A4 size)
<3> OK Top Coat+T (basis weight: 73.3 g/m², A4 size) manufactured by Oji Paper Co., Ltd.
<4> OK Top Coat+Y (basis weight: 73.3 g/m², A4 size) manufactured by Oji Paper Co., Ltd.

Thereafter, whether paper wrinkle, image peeling, and sheet jam occurred was visually checked and evaluated according to the following evaluation criteria.

### (Evaluation Criteria)

A: Neither paper jam nor paper wrinkling occurred and no image peeling was observed in any paper type.
B: Paper wrinkle and image peeling occurred in one paper type.
C: Paper wrinkling and image peeling occurred in two paper types.
D: Paper wrinkling and image peeling occurred in three or more paper types, or a sheet jam occurred.

TABLE V

| | FIXING DEVICE | | | | | | |
|---|---|---|---|---|---|---|---|
| | | SUPPORT BODY | | | | | |
| | | | | Si—Al ALLOY | | | |
| EXAMPLE | | | | | METAL | | EVALUATION |
| OR | | | | | CONTENT | | OF |
| COMPARATIVE | | | | | [% BY MASS] | | CONVEYANCE |
| EXAMPLE | No. | No. | SHAPE | No. | Si | Cu | PERFORMANCE |
| EXAMPLE 12 | 18 | B1-1 | HOLLOW CYLINDER | 1 | 7.5 | 0.1 | A |
| EXAMPLE 13 | 19 | B1-2 | HOLLOW CYLINDER | 2 | 5.0 | 0.1 | A |
| EXAMPLE 14 | 20 | B1-3 | HOLLOW CYLINDER | 3 | 10.0 | 0.2 | A |
| EXAMPLE 15 | 21 | B1-4 | HOLLOW CYLINDER | 4 | 12.0 | 1.1 | B |
| EXAMPLE 16 | 22 | B1-5 | HOLLOW CYLINDER | 5 | 1.0 | 0.2 | B |
| EXAMPLE 17 | 23 | B1-6 | HOLLOW CYLINDER | 6 | 6.0 | 2.0 | C |
| EXAMPLE 18 | 24 | B1-7 | HOLLOW CYLINDER | 7 | 7.4 | 5.0 | C |
| COMPARATIVE | 25 | B1-8 | HOLLOW CYLINDER | 8 | 0.8 | 0.2 | D |
| EXAMPLE 7 | | | | | | | |
| COMPARATIVE | 26 | B1-9 | HOLLOW CYLINDER | 9 | 0.6 | 0.1 | D |
| EXAMPLE 8 | | | | | | | |
| COMPARATIVE | 27 | B1-10 | HOLLOW CYLINDER | 10 | 13.0 | 1.0 | D |
| EXAMPLE 9 | | | | | | | |
| COMPARATIVE | 28 | B1-11 | HOLLOW CYLINDER | 11 | 18.0 | 6.0 | D |
| EXAMPLE 10 | | | | | | | |

### F. Remarks

As Tables IV and V show, the conveyance performances of the comparative examples were all evaluated as D, whereas the conveyance performances of the examples were evaluated as A, B, or C. This indicates that the examples are superior to the comparative examples.

Although embodiments of the present invention have been described and shown in detail, the disclosed embodiments are made for purposes of illustration and example only and not limitation. The scope of the present invention should be interpreted by terms of the appended claims.

1. An image forming apparatus comprising:
a support body;
an elastic member in close contact with the support body;
an endless belt; and
a nip portion, wherein:
the nip portion is formed by the elastic member and the endless belt,
the support body in close contact with the elastic member pressed at the nip portion is made of an aluminum alloy containing silicon, and
a content of silicon in the aluminum alloy is within a range of 0.8 to 12.0% by mass.

2. The image forming apparatus according to claim 1, wherein:
the endless belt conveys a recording medium, and
at least one of the nip portion is formed by the elastic member and the belt that conveys the recording medium.

3. The image forming apparatus according to claim 1, wherein a content of copper in the aluminum alloy is 1.1% by mass or less.

4. The image forming apparatus according to claim 1, wherein the nip portion is formed by the endless belt and two rotatable bodies that face each other with the endless belt in-between.

5. The image forming apparatus according to claim 1, wherein:
the support body in close contact with the elastic member pressed at the nip portion is disposed inside the endless belt, and
the image forming apparatus further includes a rotatable pressure member that is disposed outside the endless belt and that presses the elastic member at the nip portion.

6. The image forming apparatus according to claim 1, further comprising a transfer unit, wherein the nip portion is formed by components of the transfer unit.

7. The image forming apparatus according to claim 1, further comprising a fixing unit, wherein the nip portion is formed by components of the fixing unit.

8. The image forming apparatus according to claim 7, wherein the fixing unit includes a heating member.
